(19) United States
(12) Patent Application Publication
(10) Pub. No.: US 2021/0109357 A1
(43) Pub. Date: Apr. 15, 2021

(54) DISPLAY SYSTEM, DISPLAY DEVICE AND DISPLAY CONTROL METHOD

(71) Applicant: Panasonic Intellectual Property Management Co., Ltd., Osaka (JP)

(72) Inventors: Satoshi MATSUI, Kyoto (JP); Norikazu KATSUYAMA, Osaka (JP)

(21) Appl. No.: 17/130,382

(22) Filed: Dec. 22, 2020

Related U.S. Application Data
(63) Continuation of application No. PCT/JP2019/040847, filed on Oct. 17, 2019.

(30) Foreign Application Priority Data
Oct. 19, 2018 (JP) 2018-197983

(51) Int. Cl. G02B 27/01; B60R 11/02

(52) U.S. Cl. CPC G02B 27/0179; B60R 11/0229; B60R 2300/8086; B60R 2300/205; B60R 2300/308; G02B 2027/0183

(57) ABSTRACT

The present disclosure provides a display system that detects a first posture variation of a moving body having a first axis as a rotation axis, a display processing device that controls a display position of an image based on a reference position and a correction amount, and a correction processing device that sets the correction amount based on magnitude of the first posture variation. The detection device detects a second posture variation of the moving body having a second axis orthogonal to the first axis as a rotation axis. The correction processing device corrects interference of the second posture variation with respect to magnitude of the first posture variation based on magnitude of the second posture variation in setting of the correction amount.

### CROSS-REFERENCE TO RELATED APPLICATIONS

This is a continuation application of International Application No. PCT/JP2019/040847, with an international filing date of Oct. 17, 2019, which claims priority of Japanese Patent Application No.2018-197983 filed on Oct. 19, 2018, the content of which is incorporated herein by reference.

### BACKGROUND

### 1. Technical Field

The present disclosure relates to a display system, a display device and a display control method for controlling a display position of an image according to a movement of a moving body.

### 2. Description of Related Art

JP 2015-101311 A discloses a vehicle information projection system that performs augmented reality (AR) display using a head-up display (HUD) device. The HUD device projects light representing a virtual image on the windshield of a vehicle so that a viewer who is an occupant of the vehicle visually recognizes the virtual image together with an actual view of the outside world of the vehicle. For example, a virtual image representing a guide route of the vehicle is displayed in association with a display target, for example, a road, in an actual view. In this manner, the occupant can confirm the guide route while visually recognizing the actual view. The vehicle information projection system of Patent Document 1 corrects a display position of the virtual image according to an acceleration. This restricts generation of position displacement of the virtual image when the vehicle is suddenly decelerated and suddenly accelerated.

### SUMMARY

The present disclosure provides a display system, a display device, and a display control method that suppress position displacement of an image with high accuracy.

A display system of the present disclosure includes a detection device that detects a first posture variation of a moving body having a first axis as a rotation axis, a display processing device that controls a display position of an image based on a reference position and a correction amount, and a correction processing device that sets the correction amount based on magnitude of the first posture variation. The detection device detects a second posture variation of the moving body having a second axis orthogonal to the first axis as a rotation axis, and the correction processing device corrects interference of the second posture variation with respect to magnitude of the first posture variation based on magnitude of the second posture variation in setting of the correction amount.

The display device of the present disclosure includes an acquisition unit that acquires posture variation information indicating a first posture variation of a moving body having a first axis as a rotation axis and a second posture variation of the moving body having a second axis orthogonal to the first axis as a rotation axis, a display unit that displays an image at a display position based on a reference position and a correction amount, and a controller that sets the correction amount based on magnitude of the first posture variation. The controller corrects interference of the second posture variation with respect to magnitude of the first posture variation based on magnitude of the second posture variation in setting of the correction amount.

A display control method of the present disclosure is performed by an arithmetic unit of a computer. The display control method includes acquiring posture variation information indicating a first posture variation of a moving body having a first axis as a rotation axis and a second posture variation of the moving body having a second axis orthogonal to the first axis as a rotation axis, displaying an image at a display position based on a reference position and a correction amount, and setting the correction amount based on magnitude of the first posture variation. Interference of the second posture variation with respect to magnitude of the first posture variation is corrected based on magnitude of the second posture variation in setting of the correction amount.

These general and specific aspects may be realized by a system, a method, and a computer program, and a combination of these.

According to the display system, the display device, and the display control method of the present disclosure, in setting of the correction amount based on magnitude of the first posture variation of the moving body having the first axis as a rotation axis, interference with respect to the magnitude of the first posture variation by the second posture variation of the moving body having the second axis as a rotation axis is corrected based on magnitude of the second posture variation. In this manner, it is possible to suppress the position displacement of the image with high accuracy.

### BRIEF DESCRIPTION OF THE DRAWINGS

FIG. 1 is a diagram for explaining a head-up display (HUD) according to a first embodiment.

FIG. 2 is a block diagram showing a configuration of a display system according to the first embodiment.

FIG. 3 is a diagram showing an example of an actual view as seen from a windshield.

FIG. 4 is a diagram showing an example of a virtual image.

FIG. 5A shows a vehicle that is not leaning.

FIG. 5B is a diagram for explaining an example in which the virtual image is displayed at a reference position when a vehicle is not leaning.

FIG. 6A shows a vehicle in a forward leaning posture.

FIG. 6B is a diagram for explaining an example in which position displacement of the virtual image is generated when a vehicle is in the forward leaning posture.

FIG. 7 is a diagram for explaining correction of a display position of the virtual image.

FIG. 8A is a diagram showing an example in which a gyro sensor is attached to the vehicle without being inclined.

FIG. 8B is a diagram showing an example in which the gyro sensor is inclined and attached to the vehicle.

FIG. 9A is a diagram for explaining detection of an angular velocity when the gyro sensor is attached to the vehicle without being inclined.

FIG. 9B is a diagram for explaining detection of an angular velocity when the gyro sensor is inclined and attached to the vehicle.

FIG. 10 is a diagram for explaining detection of an angular velocity in a case where there is a sensitivity error in other axes.

FIG. 11 is a flowchart showing display processing in the first embodiment.

FIG. 12 is a flowchart showing correction processing in the first embodiment.

FIG. 13 is a diagram for explaining calculation of a displacement amount of an own axis, and calculation and resetting of a correction amount in the first embodiment.

FIG. 14 is a diagram for explaining calculation of a displacement amount of other axes and resetting of the displacement amount in the first embodiment.

FIG. 15 is a diagram for explaining another example of resetting of a correction amount of an own axis in the first embodiment.

FIG. 16 is a diagram for explaining still another example of resetting of a correction amount of an own axis in the first embodiment.

FIG. 17 is a flowchart showing display processing in a second embodiment.

FIG. 18 is a flowchart showing the correction processing in the second embodiment.

FIG. 19 is a diagram for explaining setting of an offset value in the second embodiment.

FIG. 20A is a flowchart showing correction processing in a third embodiment.

FIG. 20B is a flowchart showing correction processing in a variation of the third embodiment.

FIG. 21A is a flowchart showing correction processing in a fourth embodiment.

FIG. 21B is a flowchart showing the correction processing in the fourth embodiment.

FIG. 22 is a block diagram showing a configuration of a correction processing device in a fifth embodiment.

FIG. 23 is a flowchart showing correction processing in the fifth embodiment.

FIG. 24 is a block diagram showing a functional configuration of a correction controller in a sixth embodiment.

FIG. 25 is a block diagram showing a configuration of a correction processing device in a seventh embodiment.

FIG. 26 is a flowchart showing correction processing in the seventh embodiment.

FIG. 27 is a block diagram showing a configuration of a display device in an eighth embodiment.

### DETAILED DESCRIPTION

(Findings that Form the Basis of the Present Disclosure)

In order to correct a display position of an image according to a posture of a moving body, a detection device that detects vibration of the moving body is attached to the moving body. As the detection device, for example, a gyro sensor that detects an angular velocity is used. If the gyro sensor is attached in a manner that an axis of the gyro sensor is inclined with respect to an axis of the moving body, the accuracy of detecting the vibration of the moving body deteriorates. For example, if the gyro sensor is inclined around a roll axis, vibrations having a pitch axis and a yaw axis as rotation axes interfere with each other in vibration detection by the gyro sensor. Specifically, a part of the vibration having the yaw axis as the rotation axis is detected as vibration having the pitch axis as the rotation axis.

As described above, since the gyro sensor is attached in a manner that the axis of the gyro sensor is inclined with respect to the axis of the moving body, interference due to posture variation of other axes is generated. In this case, if the display position of the image is corrected based on the vibration detection by the gyro sensor, the display position is displaced from a position where it displays the image. For example, in a case of an HUD system that performs augmented reality (AR) display, a display position of a virtual image may be significantly displaced with respect to a predetermined display target in an actual view, for example, a road.

Therefore, a viewer feels uncomfortable with the display of the image.

The display system, the display device, and the display control method according to the present disclosure reduce the interference due to posture variation of other axes as described above, and suppress position displacement of the image. Specifically, in the display system, the display device, and the display control method of the present disclosure, interference of a second posture variation with respect to the magnitude of a first posture variation is corrected based on the magnitude of the second posture variation in setting of a correction amount of the display position. The first posture variation is a posture variation of the moving body having a first axis as a rotation axis. The second posture variation is a posture variation of the moving body having a second axis orthogonal to the first axis as a rotation axis. Since the correction amount is set based on the first posture variation, the first axis is referred to as an axis to be corrected or an own axis. Since the second axis is different from the own axis, the second axis is referred to as other axes. According to the present disclosure, it is possible to control the display position of an image with a correction amount obtained by suppressing interference due to posture variation of other axes.

### First Embodiment

Hereinafter, the first embodiment will be described with reference to the drawings. In the first embodiment, a case where the moving body is a vehicle such as an automobile and the display system is a head-up display (HUD) system that displays a virtual image in front of the windshield of the vehicle will be described as an example. In the first embodiment, the correction amount of the display position is reset to zero when a variation amount set based on a displacement amount of other axes is larger than a first threshold. In this manner, the display position of the virtual image is returned to the reference position. By returning the display position to the reference position, interference due to the posture variation of other axes is eliminated in the setting of the correction amount based on the posture variation using the axis to be corrected (own axis) as the rotation axis. In the present embodiment, the own axis is the pitch axis and other axes are the yaw axis and the roll axis.

1. Configuration of Display System

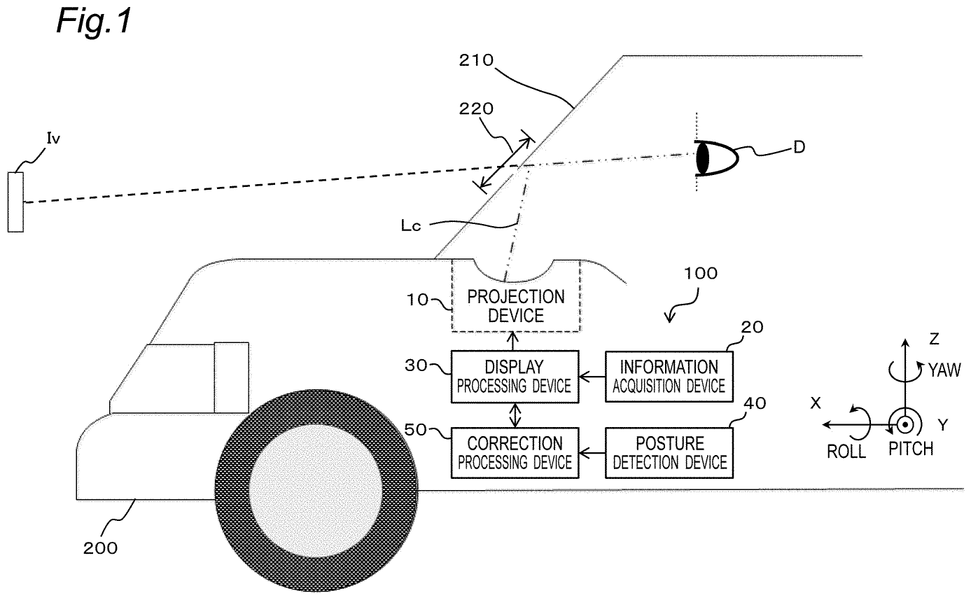

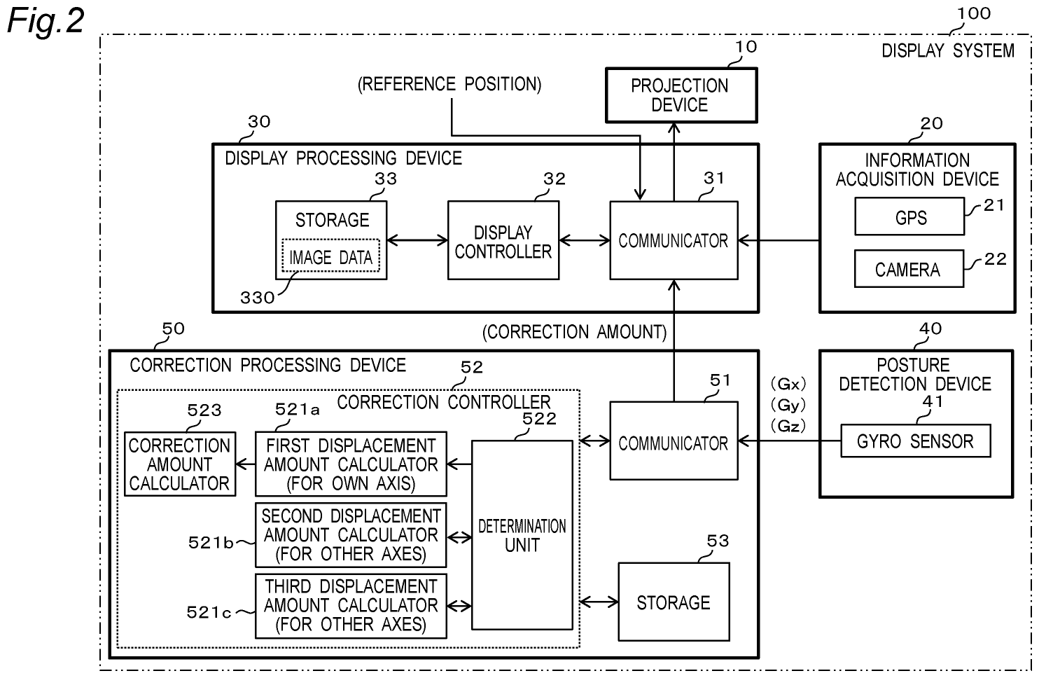

A configuration of the display system of the present embodiment will be described with reference to FIGS. 1 and 2.

FIG. 1 is a diagram for explaining an HUD. In FIG. 1, a roll axis of a vehicle 200 is the X axis, a pitch axis of the vehicle 200 is the Y axis, and a yaw axis of the vehicle 200 is the Z axis. That is, the X axis is an axis that is orthogonal to the Y axis and the Z axis and is along a line-of-sight direction of an occupant D who visually recognizes a virtual image Iv. The Y axis is an axis along the left-right direction when viewed from the occupant D who visually recognizes the virtual image Iv. The Z axis is an axis along the height direction of the vehicle 200.

A display system 100 of the present embodiment is an HUD system that performs what is called augmented reality (AR) display in which the virtual image Iv is superimposed on an actual view in front of a windshield 210 of the vehicle 200. The virtual image Iv indicates predetermined information. For example, the virtual image Iv is a figure and a character indicating a route for guiding to a destination, an estimated time of arrival at the destination, a traveling direction, a speed, various warnings, and the like. The display system 100 is installed in the vehicle 200 and projects display light Lc representing the virtual image Iv into a display area 220 of the windshield 210 of the vehicle 200. In the present embodiment, the display area 220 is a partial area of the windshield 210. Note that the display area 220 may be the entire area of the windshield 210. The display light Lc is reflected by the windshield 210 toward the inside of the vehicle. In this manner, the occupant D in the vehicle 200 visually recognizes the reflected display light Lc as the virtual image Iv in front of the vehicle 200.

The display system 100 includes a projection device 10, an information acquisition device 20, a display processing device 30, a posture detection device 40, and a correction processing device 50.

The projection device 10 projects the display light Lc representing the virtual image Iv into the display area 220. The projection device 10 includes, for example, a liquid crystal display element that displays an image of the virtual image Iv, a light source such as an LED that illuminates the liquid crystal display element, a mirror and a lens that reflect the display light Lc of the image displayed by the liquid crystal display element onto the display area 220, and the like. The projection device 10 is installed, for example, in the dashboard of the vehicle 200.

The information acquisition device 20 acquires a position of the vehicle and information indicating a situation outside the vehicle. Specifically, the information acquisition device 20 measures a position of the vehicle 200 and generates position information indicating the position. The information acquisition device 20 generates outside-vehicle information indicating an object, a distance to the object, and the like. The object is a person, a sign, a road, or the like. The information acquisition device 20 may detect the speed of the vehicle 200 traveling on the road and generate speed information indicating the speed of the vehicle 200. The information acquisition device 20 outputs the position information and the outside-vehicle information of the vehicle 200.

The display processing device 30 controls the display of the virtual image Iv based on the position information and the outside-vehicle information of the vehicle 200 obtained from the information acquisition device 20 and outputs image data of the virtual image Iv to the projection device 10.

The posture detection device 40 detects a posture variation of the vehicle 200 and outputs posture variation information indicating the detected posture variation. In the present embodiment, the posture variation information is an angular velocity.

The correction processing device 50 calculates a correction amount of the display position of the virtual image Iv based on the posture variation information of the vehicle 200 output from the posture detection device 40. The correction processing device 50 outputs the calculated correction amount to the display processing device 30.

FIG. 2 is a block diagram showing an internal configuration of the display system 100.

In the present embodiment, the information acquisition device 20 includes a global positioning system (GPS) module 21, and a camera 22.

The GPS module 21 detects the position indicating the current position of the vehicle 200 in a geographical coordinate system. Specifically, the GPS module 21 receives radio waves from GPS satellites and measures the latitude and longitude of the receiving point. The GPS module 21 generates position information indicating the measured latitude and longitude.

The camera 22 captures an outside view and generates captured image data. The information acquisition device 20 identifies, for example, an object from the captured image data and measures a distance to the object by image processing. The information acquisition device 20 generates, as the outside-vehicle information, information indicating an object, a distance to the object, and the like.

The information acquisition device 20 outputs the position information and the outside-vehicle information to the display processing device 30. Note that the captured image data generated by the camera 22 may be output to the display processing device 30.

The display processing device 30 includes a communicator 31, a display controller 32, and a storage 33.

The communicator 31 includes a circuit that communicates with an external device according to a predetermined communication standard. The predetermined communication standard includes, for example, LAN, Wi-Fi (registered trademark), Bluetooth (registered trademark), USB, HDMI (registered trademark), controller area network (CAN), and serial peripheral interface (SPI).

The display controller 32 can be realized by a semiconductor element or the like. The display controller 32 can be composed of, for example, a microcomputer, a CPU, an MPU, a GPU, a DSP, an FPGA, and an ASIC. A function of the display controller 32 may be configured only by hardware, or may be realized by combining hardware and software. The display controller 32 realizes a predetermined function by reading data and a program stored in the storage 33 and performing various types of arithmetic processing.

The storage 33 is a storage medium that stores a program and data required to realize a function of the display processing device 30. The storage 33 can be realized by, for example, a hard disk (HDD), an SSD, a RAM, a DRAM, a ferroelectric memory, a flash memory, a magnetic disk, or a combination of these.

The storage 33 stores a plurality of pieces of image data 330 representing the virtual image Iv.

The display controller 32 determines the virtual image Iv to be displayed based on the position information and the outside-vehicle information obtained from the information acquisition device 20. The display controller 32 reads out the image data 330 of the determined virtual image Iv from the storage 33 and outputs the data to the projection device 10. The display controller 32 acquires information indicating the reference position for displaying the virtual image Iv from an external device (not shown) via the communicator 31. The display controller 32 acquires a correction amount of the display position from the correction processing device 50. The display controller 32 sets the display position of the virtual image Iv based on the reference position and the correction amount.

The posture detection device 40 includes a gyro sensor 41 that detects an angular velocity. The gyro sensor 41 outputs angular velocity information indicating the detected angular velocity to the correction processing device 50. The angular velocity information includes, for example, an angular velocity Gx having a roll axis as a rotation axis, an angular velocity Gy having a pitch axis as a rotation axis, and an angular velocity Gz having a yaw axis as a rotation axis. The angular velocity information is an example of posture variation information.

The correction processing device 50 includes a communicator 51, a correction controller 52, and a storage 53.

The communicator 51 includes a circuit that communicates with an external device according to a predetermined communication standard. The predetermined communication standard includes, for example, LAN, Wi-Fi (registered trademark), Bluetooth (registered trademark), USB, HDMI (registered trademark), controller area network (CAN), and serial peripheral interface (SPI).

The correction controller 52 can be realized by a semiconductor element or the like. The correction controller 52 can be composed of, for example, a microcomputer, a CPU, an MPU, a GPU, a DSP, an FPGA, and an ASIC. A function of the correction controller 52 may be configured only by hardware, or may be realized by combining hardware and software. The correction controller 52 realizes a predetermined function by reading data and a program stored in the storage 53 and performing various types of arithmetic processing.

The storage 53 is a storage medium that stores a program and data required to realize a function of the correction processing device 50. The storage 53 can be realized by, for example, a hard disk (HDD), an SSD, a RAM, a DRAM, a ferroelectric memory, a flash memory, a magnetic disk, or a combination of these.

The correction controller 52 includes, as a functional configuration, a first displacement amount calculator 521a, a second displacement amount calculator 521b, a third displacement amount calculator 521c, a determination unit 522, and a correction amount calculator 523.

The first displacement amount calculator 521a calculates a displacement amount of the own axis. The second displacement amount calculator 521b and the third displacement amount calculator 521c calculate displacement amounts of the other axes. The first, second, and third displacement amount calculators 521a, 521b, and 521c calculate a displacement amount of an angle around each of three axes of the vehicle 200 based on the angular velocity of the vehicle 200. For example, the first, second, and third displacement amount calculators 521a, 521b, and 521c calculate a pitch angle, a roll angle, and a yaw angle which are angles around the three axes of the vehicle 200 by performing an integral calculation of the angular velocity detected by the gyro sensor 41. This makes it possible to calculate a displacement amount of the vehicle 200 around the X axis, the Y axis, and the Z axis shown in FIG. 1. In the present embodiment, the first displacement amount calculator 521a calculates the pitch angle based on the angular velocity Gy. The second displacement amount calculator 521b and the third displacement amount calculator 521c respectively calculate the roll angle and the yaw angle based on the angular velocities Gx and Gz.

The determination unit 522 sets the variation amount based on the displacement amount calculated by the second displacement amount calculator 521b and the third displacement amount calculator 521c, compares the set variation amount with the first threshold, and outputs a comparison result. The variation amount is, for example, a larger one of the displacement amount calculated by the second displacement amount calculator 521b and the displacement amount calculated by the third displacement amount calculator 521c. In other words, in the present embodiment, the other axes that control the timing for resetting the correction amount are dynamically changed.

The correction amount calculator 523 calculates the correction amount of the display position of the virtual image Iv based on the displacement amount of the own axis calculated by the first displacement amount calculator 521a. The correction amount is indicated by the number of pixels, for example. For example, the correction amount calculator 523 converts the displacement amount of the pitch angle from an angle into the number of pixels, and determines the correction amount that eliminates the number of pixels corresponding to the displacement. The correction amount calculator 523 outputs the calculated correction amount to the display processing device 30.

The display processing device 30 and the correction processing device 50 can bidirectionally communicate with each other by the communicators 31 and 51.

2. AR Display

AR display will be described with reference to

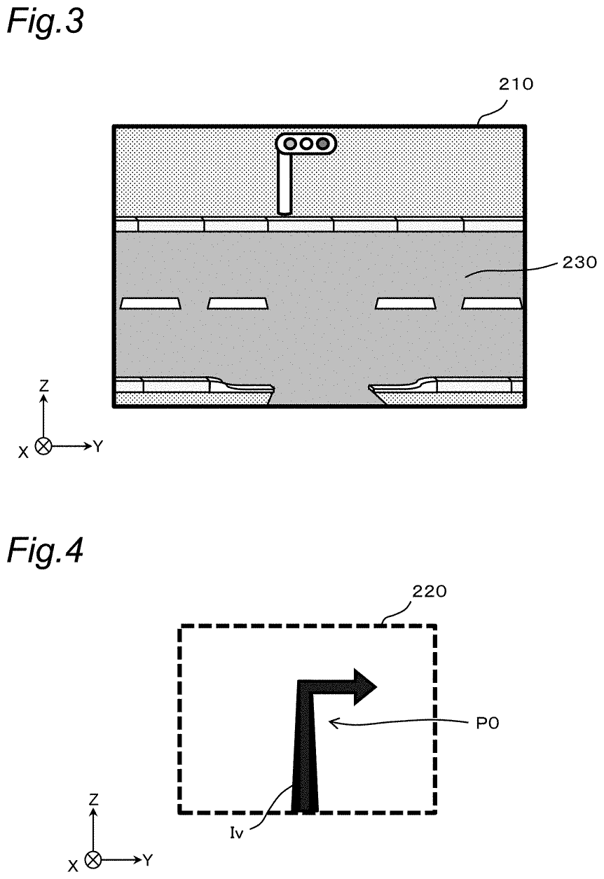

FIGS. 3 to 7.

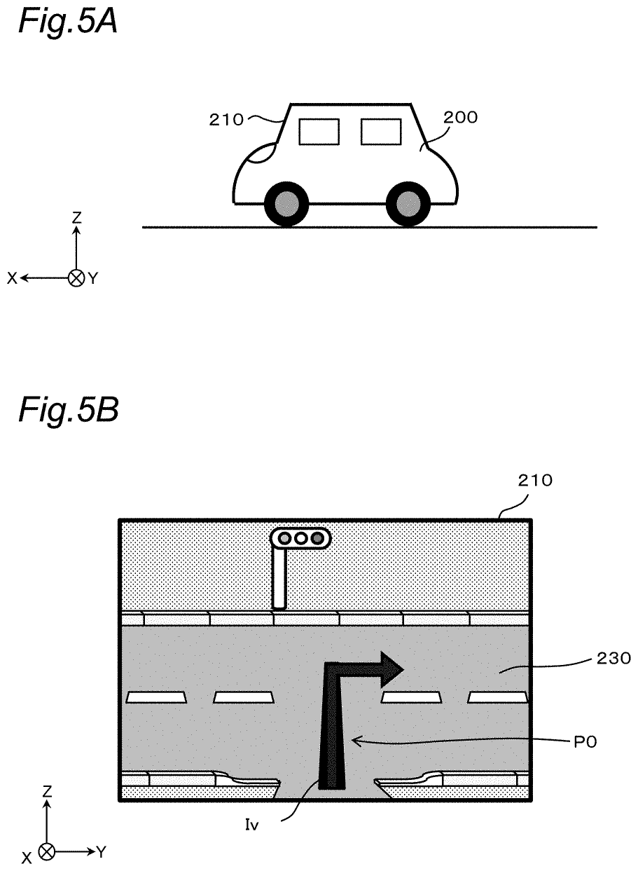

FIG. 3 shows an example of an actual view seen from the windshield 210 of the vehicle 200. FIG. 4 shows an example of the virtual image Iv seen from the display area 220. The display system 100 superimposes the virtual image Iv shown in FIG. 4 on the actual view shown in FIG. 3. A reference position P0 of the virtual image Iv is a position determined based on the type of the virtual image Iv, the state of the vehicle 200, for example, a position and a posture of the vehicle 200, map data, and the like, and the reference position P0 is determined by an external device. For example, in a case where a display target 230 is a cruising lane and the virtual image Iv is an arrow indicating a traveling direction, a display position of an arrow when the arrow indicates the center of the cruising lane at the time the vehicle is stationary is the reference position P0. The reference position P0 is set, for example, at a position of a pixel on liquid crystal display corresponding to the values of the Y coordinate and the Z coordinate in the display area 220 in FIG. 4. The reference position P0 is acquired from an external device. The external device includes, for example, a microcomputer, a CPU, an MPU, a GPU, a DSP, an FPGA, or an ASIC and the GPS module 21. A function of the external device may be configured only by hardware, or may be realized by combining hardware and software. The information indicating the reference position P0 output from the external device may change based on the number of occupants, a change in load, and a change in posture due to a decrease in gasoline, or the like. Therefore, for example, the reference position P0 acquired from the external device may be different from an initial position that is acquired initially. Therefore, the display processing device 30 may change the reference position P0 acquired from the external device based on the number of occupants, the change in the load, and the variation in the posture due to the decrease in gasoline and the like. Note that the display processing device 30 may set the reference position P0 based on the position information, the outside-vehicle information, the map data, and the like. The display processing device 30 may set the size of the virtual image Iv based on the position information and the outside-vehicle information.

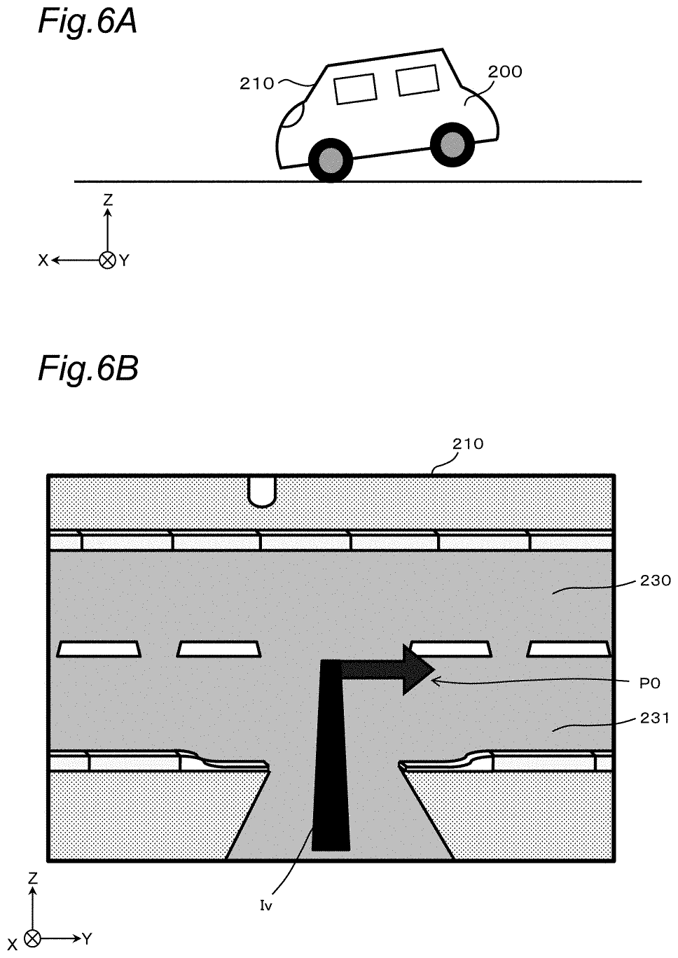

FIG. 5A shows the vehicle 200 not leaning. FIG. 5B shows a display example of the virtual image Iv when the vehicle 200 is not leaning. FIG. 5B shows a state in which the virtual image Iv shown in FIG. 4 is displayed in a manner superimposed on the actual view shown in FIG. 3. When the vehicle 200 is not leaning, if the virtual image Iv is displayed at the reference position P0 as shown in FIG. 5B, the virtual image Iv appears at a desired position to display, for example, the center of a cruising lane.

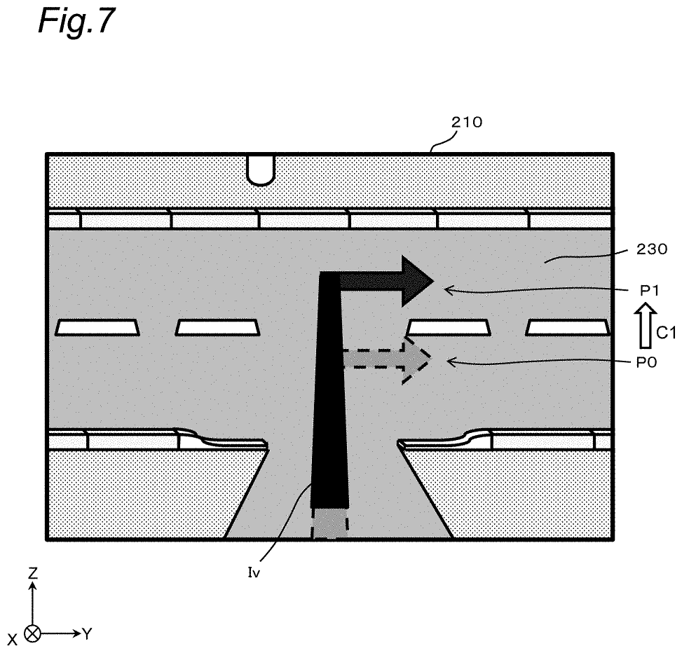

FIG. 6A shows the vehicle 200 in a forward leaning posture. FIG. 6B shows a display example of the virtual image Iv when the vehicle 200 is in the forward leaning posture. FIG. 6B illustrates a case where the display position of the virtual image Iv is displaced from the display target 230 according to the posture variation of the vehicle 200. The vehicle 200 may lean due to unevenness of the road surface, sudden acceleration or deceleration of the vehicle 200, or the like. For example, when the vehicle 200 suddenly decelerates, the vehicle 200 takes a forward leaning posture as shown in FIG. 6A. In this case, as shown in FIG. 6B, the position of display target 230 seen from windshield 210 changes according to the inclination of vehicle 200. For this reason, in a case where the virtual image Iv is displayed at the reference position P0, the virtual image Iv is displaced from the display target 230. For example, as shown in FIG. 6B, the tip of the arrow is in an opposite lane 231. Therefore, the display system 100 adjusts the display position of the virtual image Iv in the direction of eliminating the displacement according to the posture of the vehicle 200.

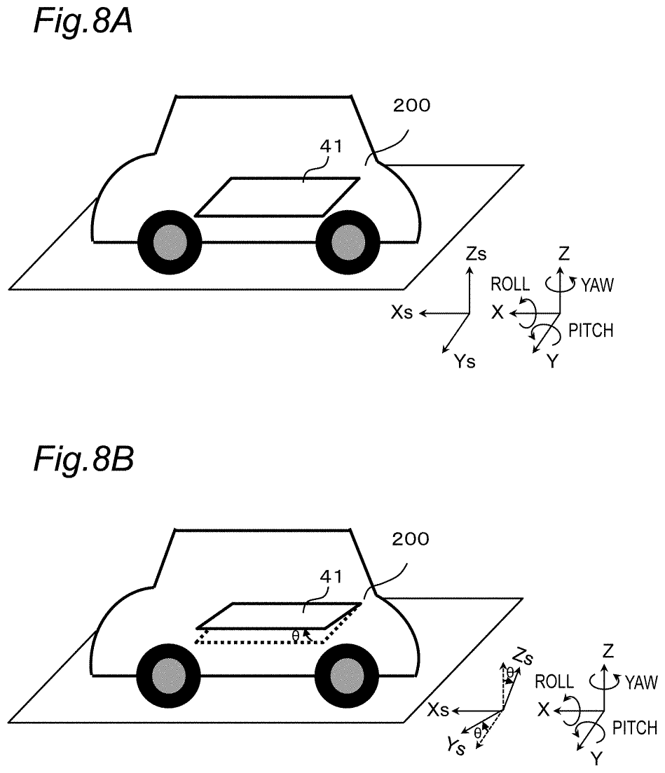

FIG. 7 shows the display position of the virtual image Iv before and after correction. The correction processing device 50 calculates a correction amount C1 so that the display position of the virtual image Iv is a position P1 where there is no displacement due to the angle of the vehicle 200. That is, the display processing device 30 sets the display position of the virtual image Iv to “reference position P0+correction amount C1”. In this manner, the projection device 10 can display the virtual image Iv at the position P1 where it displays the image with respect to the display target 230. As described above, even in a case where the vehicle 200 leans, the display position of the virtual image Iv is changed from the reference position P0 based on the correction amount C1, so that the virtual image Iv can be displayed at the position P1 where it displays the image with respect to the display target 230 in the actual view.

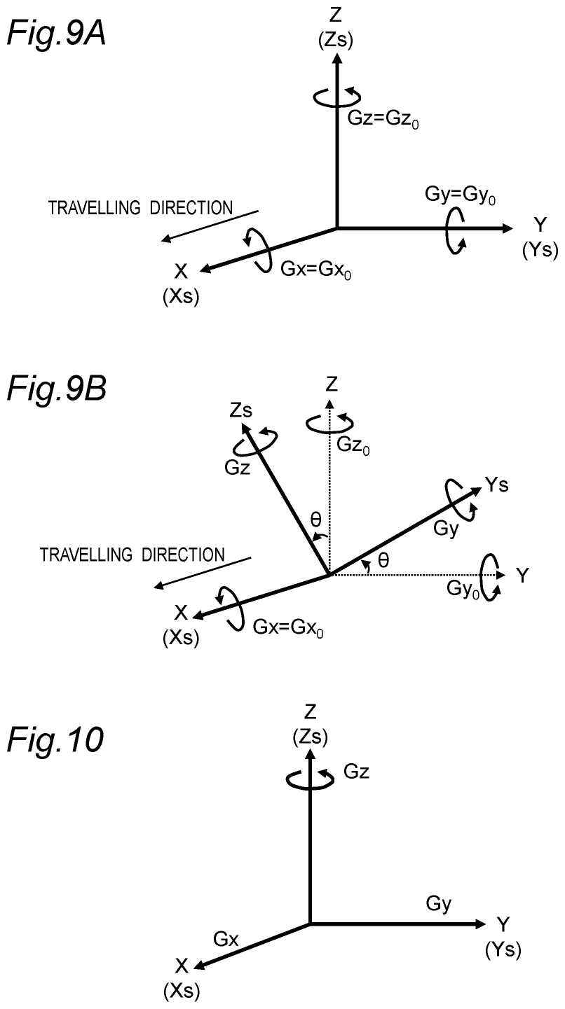

FIG. 8A and 8B are diagrams for explaining a relationship between attaching accuracy of the gyro sensor 41 to the vehicle 200 and posture detection accuracy. The gyro sensor 41 is a sensor having Xs, Ys, and Zs axes that are orthogonal to each other. In the display system 100, the gyro sensor 41 needs to be attached so that the Xs, Ys, and Zs axes of the gyro sensor 41 are parallel to the X, Y, and Z axes of the vehicle 200, respectively.

FIG. 8A shows a state in which the gyro sensor 41 is properly attached to the vehicle 200, that is, the Xs, Ys, and Zs axes of the gyro sensor 41 are attached so as to be parallel to the X, Y, and Z axes of the vehicle 200, respectively. FIG. 8B shows a state in which the gyro sensor 41 is attached to the vehicle 200 in a manner displaced from the posture of FIG. 8A by an angle θ around the Xs axis.

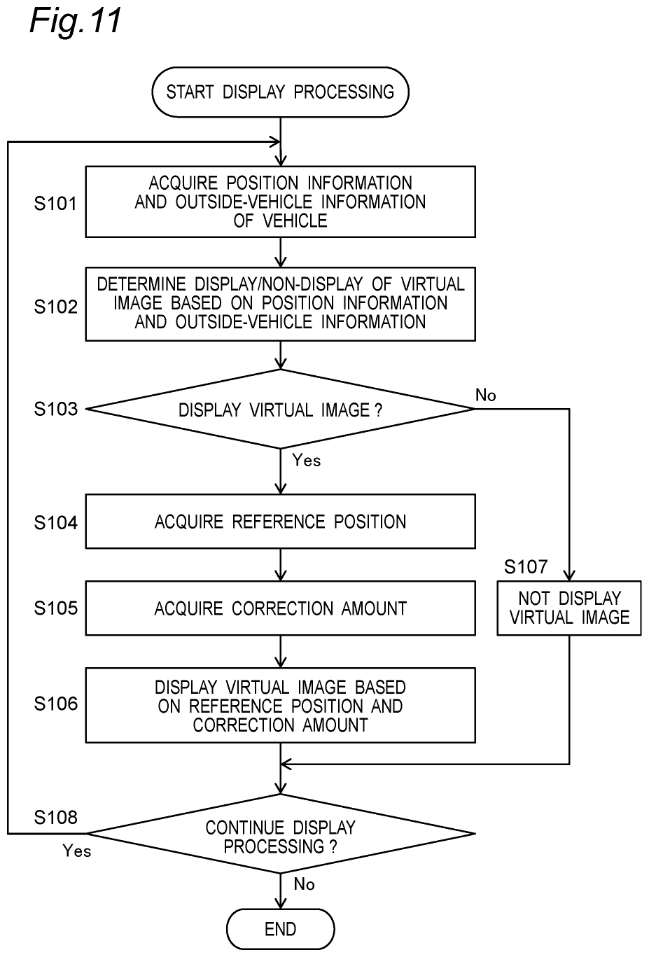

FIG. 9A is a diagram for explaining detection of an angular velocity in a case where there is no attaching error of the gyro sensor 41 as shown in FIG. 8A. In the state of FIG. 8A, the gyro sensor 41 detects an angular velocity Gx₀ around the X axis of the vehicle 200 only around the Xs axis as shown in FIG. 9A. The gyro sensor 41 detects an angular velocity Gy₀ around the Y axis only around the Ys axis. The gyro sensor 41 detects an angular velocity Gz₀ around the Z axis only around the Zs axis. That is, assume that the angular velocities when the gyro sensor 41 is not inclined are Gx₀, Gy₀, and Gz₀, the angular velocities Gx, Gy, and Gz actually detected by the gyro sensor 41 are as described below.

Roll axis: Gx=Gx₀

Pitch axis: Gy=Gy₀

Yaw axis: Gz=Gz₀

FIG. 9B is a diagram for explaining the detection of the angular velocity in a case where there is an attaching error of the gyro sensor 41. When the gyro sensor 41 is in a state of being attached to the vehicle 200 in a manner displaced by the angle θ around the X axis as shown in FIG. 8B, the gyro sensor 41 detects the angular velocity Gx₀ around the X axis only around the Xs axis as shown in FIG. 9B. However, since the gyro sensor 41 is inclined around the Xs axis, the angular velocity Gy₀ around the Y axis is decomposed into the Ys axis and the Zs axis and detected. Similarly, the angular velocity Gz₀ around the Z axis is decomposed into the Ys axis and the Zs axis and detected. That is, in FIG. 9B, assume that the angular velocities when the gyro sensor 41 is not inclined are Gx₀, Gy₀, and Gr₀, the angular velocities Gx, Gy, and Gz actually detected by the gyro sensor 41 are as described below.

Roll axis: Gx=Gx₀

Pitch axis: Gy=Gy₀×cos θ+Gz₀×sin θ

Yaw axis: Gz=Gz₀×cos θ−Gy₀×sin θ

Therefore, as shown in FIG. 8B and FIG. 9B, the gyro sensor 41 attached to the vehicle 200 in an inclined manner cannot accurately detect vibrations around the Y axis and the Z axis of the vehicle 200. For example, when the angular velocity around the yaw axis becomes large, such as when the vehicle 200 goes around a curve, the value of “Gz₀×sin θ” on the pitch axis to be corrected becomes larger than “Gy₀×cos θ”, for example. That is, in the vibration detection of the pitch axis, a vibration component of the yaw axis becomes larger than a vibration component of the pitch axis. Generally, when the vehicle 200 goes around a curve or the like, the angular velocity Gz₀ of the vehicle 200 around the Z axis becomes considerably larger than the angular velocity Gy₀ of the vehicle 200 around the Y axis. For this reason, the correction processing device 50 cannot accurately calculate the displacement amount of the vehicle 200 having the pitch axis as the rotation axis, and the virtual image Iv of FIG. 1 is displaced with respect to a predetermined display target in the actual view when displayed.

As described above, if there is an attaching error of the gyro sensor 41, other axis interference caused by addition of a component of vibration of the other axes is generated in the detection of the angular velocity of the axis to be corrected. The display system 100 of the present embodiment reduces the interference component of the other axes in the calculation of the correction amount. Specifically, when the variation amount set based on the angular velocity of the other axes is larger than the first threshold, the correction amount is reset to zero. This eliminates the interference of the posture variation with the other axes as the rotation axis.

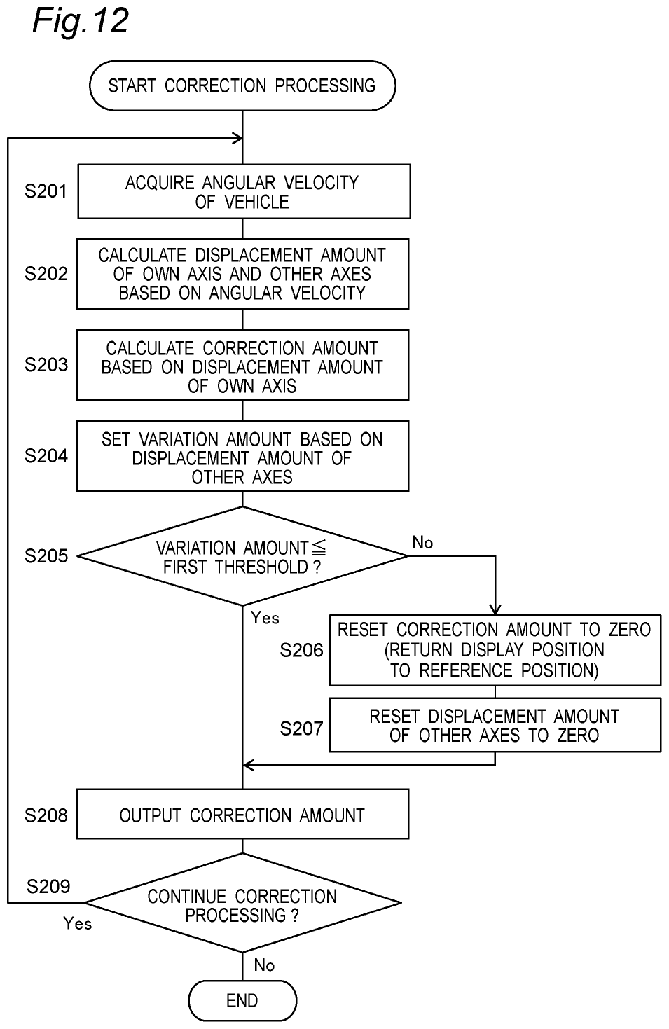

In the present embodiment, since the correction amount is reset to zero, it is possible, for example, to reduce or eliminate the interference due to the other axes sensitivity error depending on the device characteristics of the gyro sensor 41. For example, the detection accuracy of vibration may be deteriorated due to the other axes sensitivity error even in a case where the gyro sensor 41 is not attached in an inclined manner as shown in FIG. 8A, due to the device characteristics. For example, as shown in FIG. 10, in a case where vibration only around the yaw axis occurs, a component of the angular velocity around the yaw axis may be added to the angular velocity Gx around the roll axis and the angular velocity Gy around the pitch axis. For example, assume that the angular velocities when there is no attaching error of the gyro sensor 41 are Gx₀, Gy₀, and Gz₀ and the other axes sensitivity error is j (%), the angular velocities Gx, Gy, and Gz actually detected by the gyro sensor 41 are as described below.

Roll axis: Gx=Gx₀+Gz₀×j/100

Pitch axis: Gy=Gy₀+Gz₀×j/100

Yaw axis: Gz=Gz₀

In this case, when calculating the displacement amount of the vehicle 200 having the pitch axis as the rotation axis based on the angular velocity Gy of the pitch axis, the correction processing device 50, which is affected by “Gz₀×j/100”, cannot accurately calculate the displacement amount. In a case where the image is displayed with the correction amount calculated based on such a displacement amount, the virtual image Iv in FIG. 1 is displayed in a manner displaced with respect to a predetermined display target in the actual view.

However, in the present embodiment, threshold determination is performed by including the variation amount caused by the other axes sensitivity error before resetting is performed, so that the interference due to the other axes sensitivity error can be eliminated by the resetting.

3. Operation of Display Processing Device

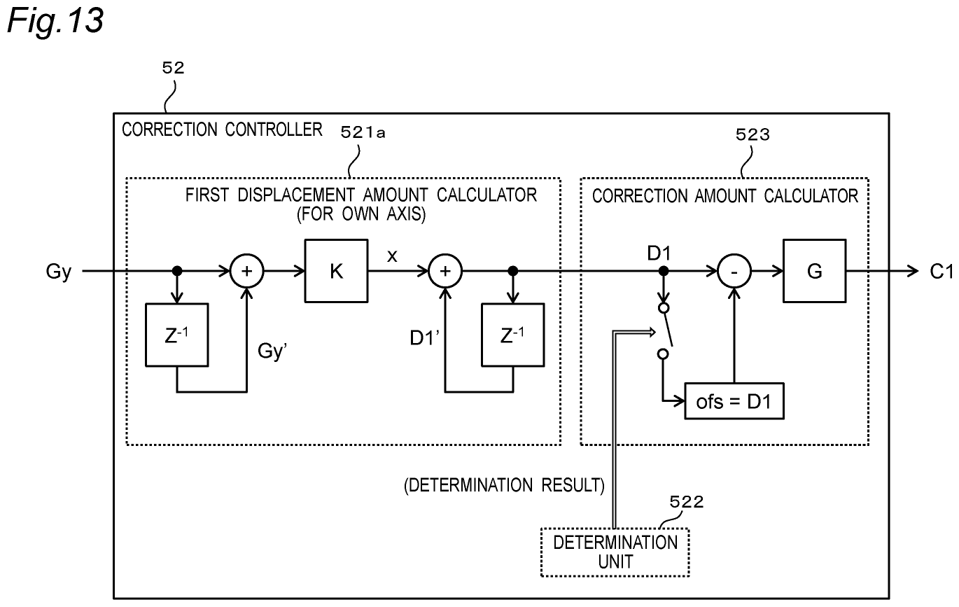

The operation of the display controller 32 of the display processing device 30 will be described with reference to FIG. 11. FIG. 11 shows the display processing performed by the display controller 32 of the display processing device 30. The display processing shown in FIG. 11 is started, for example, when the engine of the vehicle 200 is started or when a button for instructing the start of displaying the virtual image Iv is operated.

The display controller 32 acquires the position information and the outside-vehicle information of the vehicle 200 from the information acquisition device 20 (S101). The display controller 32 determines whether or not to display the virtual image Iv corresponding to the display target based on the position information and the outside-vehicle information (S102).

In a case of determining to display the virtual image Iv (Yes in S103), the display controller 32 acquires information indicating the reference position P0 of the virtual image Iv from an external device (S104). The display controller 32 acquires information indicating the correction amount C1 of the display position output from the correction processing device 50 (S105). The display controller 32 causes the projection device 10 to display the virtual image Iv based on the reference position P0 and the correction amount C1 (S106). For example, the display controller 32 reads the image data 330 of the virtual image Iv corresponding to the display target from the storage 33, sets the display position of the virtual image Iv to “reference position P0+correction amount C1”, and outputs the image data 330 and information indicating the display position to the projection device 10.

In a case of determining not to display the virtual image Iv (No in S103), the display controller 32 hides the virtual image Iv (S107). For example, the display controller 32 outputs a command to stop the display of the virtual image Iv to the projection device 10.

The display controller 32 determines whether or not to continue the display processing (S108). For example, the display controller 32 ends the display processing when the engine of the vehicle 200 is stopped or when a button for giving an instruction to end the display of the virtual image Iv is operated. In this case, the display controller 32 stops the display of the virtual image Iv by the projection device 10. In a case where the display processing is continued, the processing returns to Step S101.

4. Operation of Correction Processing Device

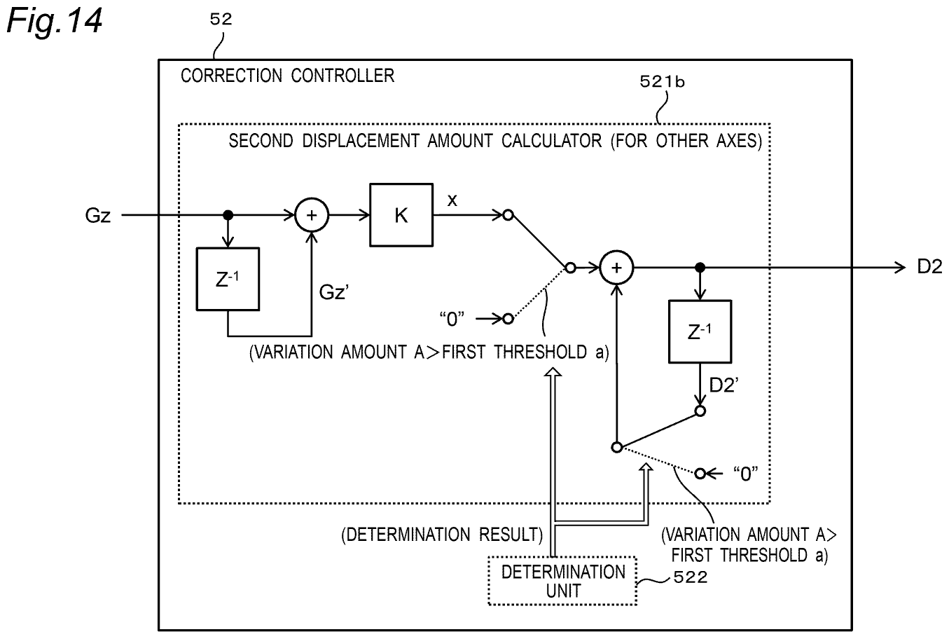

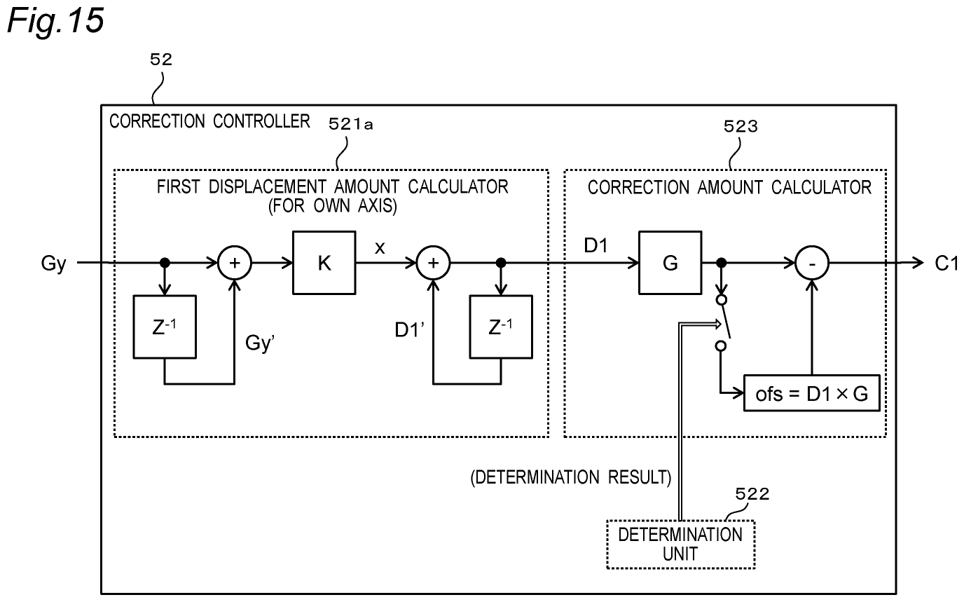

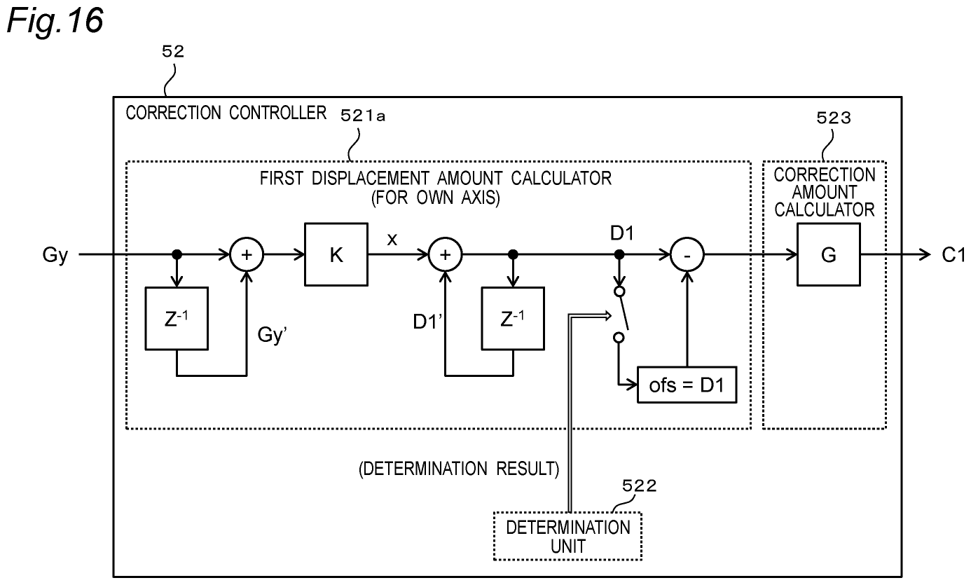

The operation of the correction controller 52 of the correction processing device 50 according to the first embodiment will be described with reference to FIGS. 12 to 14. FIG. 12 shows the correction processing performed by the correction controller 52 of the correction processing device 50. FIG. 13 shows a functional configuration of the first displacement amount calculator 521a for the own axis and the correction amount calculator 523. FIG. 14 shows a functional configuration of the second displacement amount calculator 521b for the other axes. The functional configuration of the third displacement amount calculator 521c for the other axes is the same as that of the second displacement amount calculator 521b.

The correction processing shown in FIG. 12 is started, for example, when the engine of the vehicle 200 is started or when a button for instructing the start of displaying the virtual image Iv is operated. The correction processing of FIG. 12 is started, for example, together with the display processing of FIG. 11. Note that the correction processing shown in FIG. 12 may be started when the button for instructing the start of the position correction of the virtual image Iv is operated.

The correction controller 52 acquires the angular velocity information indicating the angular velocities Gx, Gy, and Gz of the vehicle 200 output from the gyro sensor 41 (S201). The first displacement amount calculator 521a, the second displacement amount calculator 521b, and the third displacement amount calculator 521c calculate displacement amounts D1, D2, and D3 of the vehicle 200 around the pitch axis, the roll axis, and the yaw axis based on the angular velocities Gy, Gx, and Gz, respectively (S202). The displacement amounts D1, D2, and D3 are angles around the pitch axis, the roll axis, and the yaw axis, respectively. For example, as shown in FIG. 13, the first displacement amount calculator 521a calculates the displacement amount D1 from “D1=D1′+x”. In FIG. 13, D1′ is a previous displacement amount, and x is a calculated value in an integral calculation process. The calculated value x is calculated by “x=(Gy+Gy′)×K”. K is a filter coefficient. Gy is the angular velocity acquired in Step S201, and Gy′ is a previous angular velocity. The second displacement amount calculator 521b calculates the displacement amount D2 from “D2=D2′+x”, for example, as shown in FIG. 14. Similarly, the third displacement amount calculator 521c calculates the displacement amount D3 from “D3=D3′+x”.

The correction amount calculator 523 calculates the correction amount C1 of the display position of the virtual image Iv based on the displacement amount D1 of the own axis (S203). For example, as shown in FIG. 13, the correction amount calculator 523 calculates the correction amount C1 from “C1=(D1−ofs)×G”. Here, G is a conversion coefficient for converting an angle into the number of pixels. That is, the correction amount calculator 523 converts the displacement amount D1, which is the angle of the vehicle 200, into the number of pixels, and determines the correction amount C1 that cancels the displacement amount indicated by the number of pixels. An initial value of the offset value ofs is, for example, zero.

The determination unit 522 sets a variation amount A based on the displacement amounts D2 and D3 of the other axes (S204). In the present embodiment, the variation amount A is the larger one of the displacement amount D2 and the displacement amount D3.

Note that the variation amount A may be the displacement amount D2 or the displacement amount D3. For example, the displacement amount D2 or the displacement amount D3 having the maximum possible value may be determined in advance as the variation amount A. In other words, the other axes may be determined in advance. The variation amount A may be calculated, for example, from Equation (1).

[Equation 1]

A=\sqrt{D2²+D3²} (1)

The determination unit 522 determines whether or not the variation amount A is equal to or less than a first threshold a (S205). The first threshold a is a predetermined value.

In a case where the determination unit 522 determines that the variation amount A is larger than the first threshold a (No in S205), the correction amount calculator 523 resets the correction amount C1 to zero (S206). For example, the correction amount calculator 523 sets the current displacement amount D1 as the offset value ofs in FIG. 13 (ofs =D1). In this manner, the calculation of the correction amount C1, “C1=(D1−ofs)×G”, in the correction amount calculator 523 becomes “c=0×G” from “ofs=D1”. Therefore, the correction amount C1 calculated by the correction amount calculator 523 becomes zero.

Furthermore, in a case where the determination unit 522 determines that the variation amount A is larger than the first threshold a (No in S205), the second displacement amount calculator 521b and the third displacement amount calculator 521c reset the displacement amounts D2 and D3 to zero (S207). For example, as shown in FIG. 14, the second displacement amount calculator 521b sets x=0 and D2′=0. This resets the displacement amount D2 to zero. By setting “x=0” and “D2′=0”, an integration filter in the second displacement amount calculator 521b is reset. Similarly, in the third displacement amount calculator 521c, the displacement amount D3 is reset to zero by resetting an integration filter.

The correction amount calculator 523 outputs the correction amount C1 calculated in Step S203 or the correction amount C1 calculated in Step S206 to the display processing device 30 (S208).

The correction controller 52 determines whether or not to continue the correction processing (S209). In a case where the correction processing is continued (Yes in S209), the processing returns to Step S201. In a case where the correction processing is not continued (No in S209), the processing shown in FIG. 12 is finished.

5. Effect, Supplement, and the Like

The display system 100 of the present disclosure includes the posture detection device 40, the display processing device 30, and the correction processing device 50. The posture detection device 40 detects a first posture variation of the moving body having the first axis as the rotation axis. The first axis is the axis to be corrected (own axis), and is the pitch axis in the present embodiment. The correction processing device 50 sets the correction amount C1 based on the magnitude of the first posture variation. The display processing device 30 controls the display position of the image based on the reference position P0 and the correction amount C1. The posture detection device 40 further detects a second posture variation of the moving body having a second axis orthogonal to the first axis as the rotation axis. The second axis is the other axis with respect to the axis to be corrected. The other axes that are the second axes include a plurality of axes that are different from the first axis and are orthogonal to each other, and in the present embodiment, are the roll axis and the yaw axis. In the setting of the correction amount C1, the correction processing device 50 corrects the interference of the second posture variation with respect to the magnitude of the first posture variation based on the magnitude of the second posture variation.

In this manner, it is possible to control the display position of the image with a correction amount obtained by suppressing interference due to posture variation of the other axes. Therefore, the position displacement of the image is suppressed.

In the present embodiment, the correction of the interference based on the magnitude of the second posture variation means that the correction processing device 50 sets an inclination amount of the posture of the moving body with respect to the second axis based on the second posture variation, and resets the correction amount C1 to zero when the inclination amount of the posture is larger than the first threshold. In the present embodiment, the first and second posture variations are angular velocities. The inclination amount of the posture of the moving body with respect to the second axis is the variation amount A set based on the displacement amounts D2 and D3. That is, in the present embodiment, the inclination amount of the posture is represented by an angle.

By resetting the correction amount C1 to zero, it is possible to eliminate the influence of the error due to an interference component of the other axes, for example, “Gz₀×sin θ”. The present embodiment is capable of reducing or eliminating interference in both the other axis interference caused by the attaching error of the gyro sensor 41 and the other axis interference due to the other axes sensitivity error depending on the device characteristics of the gyro sensor 41.

In the present embodiment, the correction processing device 50 sets, as the second posture variation, the largest one of the posture variations of the moving body having a plurality of axes that are the other axes as the rotation axis. That is, a larger one of the displacement amounts D2 and D3 is set as the variation amount A and compared with the first threshold a. In other words, in the present embodiment, the other axes that control the timing of resetting the correction amount are dynamically changed in Step S204. However, the other axes may be determined in advance. For example, a maximum value that the roll angle can take due to the variation of the vehicle 200 is 90 degrees, and a maximum value that the yaw angle can take is generally 90 degrees or more. Therefore, for example, the yaw axis having a larger maximum value may be predetermined as the other axis. In this manner, for example, a detection system around the roll axis becomes unnecessary, and the circuit scale can be reduced. Therefore, the cost of the correction processing device 50 can be reduced.

The display system 100 of the present embodiment further includes the projection device 10 that projects light representing an image. In the present embodiment, the moving body is a vehicle, and the image is a virtual image displayed in front of the windshield of the vehicle. According to the present embodiment, it is possible to suppress the displacement of the display position of the virtual image with high accuracy.

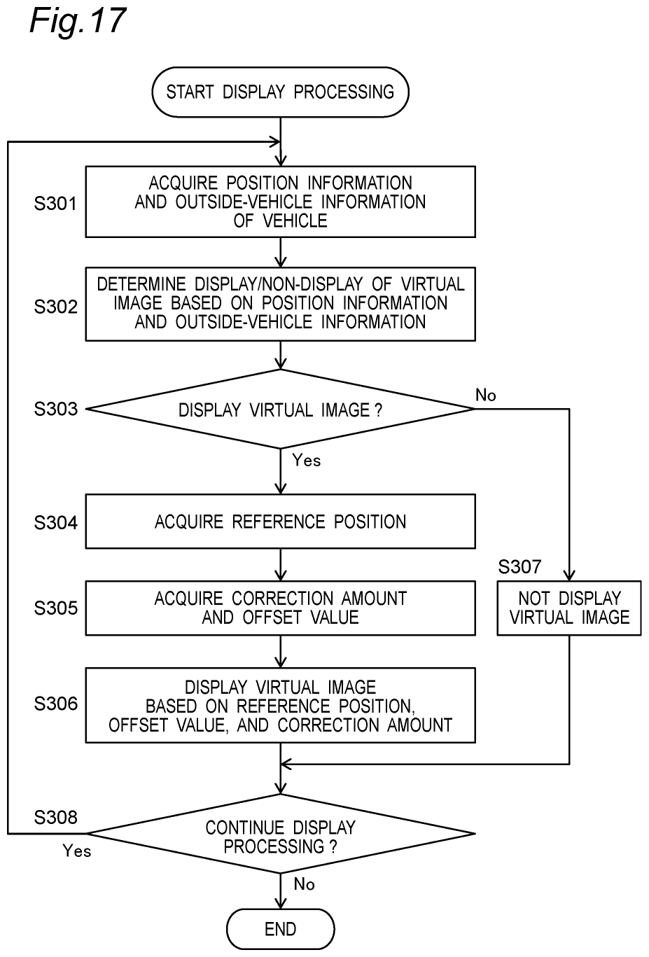

Although the offset value ofs is an angle in FIG. 13, the offset value ofs may also be the number of pixels. FIG. 15 shows another example of the functional configuration of the correction controller 52 in the first embodiment. For example, as shown in FIG. 15, the correction amount calculator 523 calculates the correction amount C1 from “C1=D1×G−ofs”. In this case, the correction amount calculator 523 sets “D1×G” when the variation amount A is larger than the first threshold a as the offset value ofs (ofs=D1×G). In this manner, the correction amount C1 when the variation amount A is larger than the first threshold a may be reset to zero.

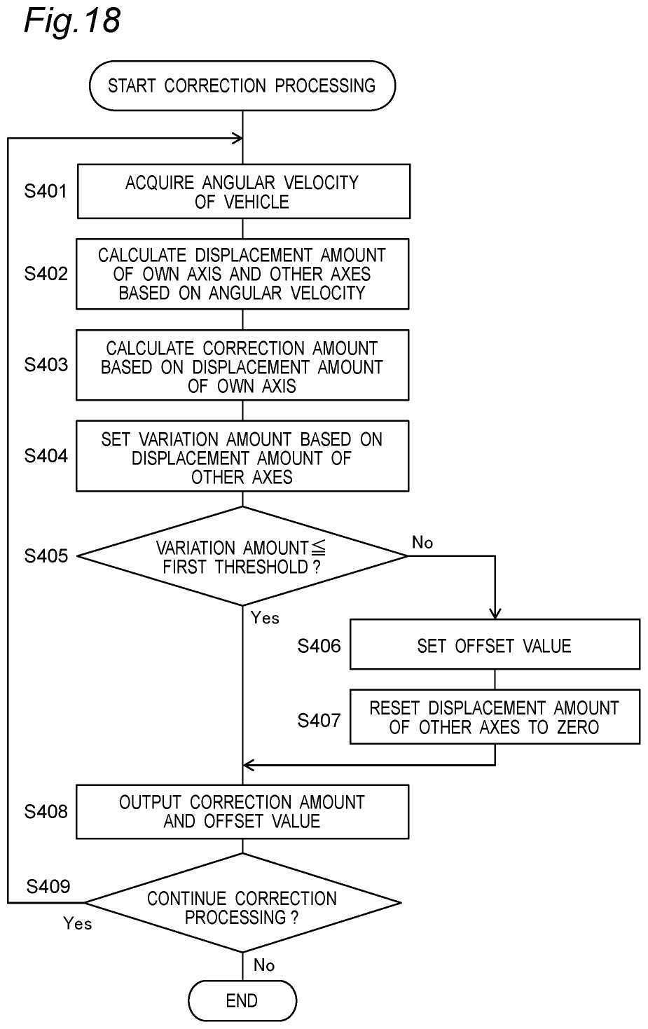

Furthermore, the correction amount C1 may be reset to zero by another method. FIG. 16 shows still another example of the functional configuration of the correction controller 52 of the first embodiment. In this example, the first displacement amount calculator 521a outputs a difference “D1−ofs” between the displacement amount D1 and the offset value ofs to the correction amount calculator 523. The offset value ofs in FIG. 16 is the same as the offset value ofs in FIG. 13. The displacement amount D1 when the variation amount A is larger than the first threshold a is set as the offset value ofs (ofs=D1). In this manner, the correction amount C1 when the variation amount A is larger than the first threshold a may be reset to zero.

In the present embodiment, two displacement amount calculators, the second displacement amount calculator 521b and the third displacement amount calculator 521c, are included for the other axes. However, the configuration may be such that either one of them is included. For example, in a case where the own axis is the pitch axis, the other axis may be either the roll axis or the yaw axis.

In the present embodiment, the case where the axis to be corrected is the pitch axis is illustrated. However, the axis to be corrected may be the roll axis or the yaw axis. The first threshold a when the axis to be corrected is the pitch axis, the first threshold a when the axis to be corrected is the yaw axis, and the first threshold a when the axis to be corrected is the roll axis may have different values.

### Second Embodiment

In the first embodiment, the correction amount calculator 523 of the correction processing device 50 outputs the correction amount C1 adjusted by the offset value ofs, and the display processing device 30 sets the display position of the virtual image Iv to the “reference position P0 +correction amount C1”. In the present embodiment, the correction amount calculator 523 outputs the correction amount C1 and the offset value ofs. That is, in the present embodiment, the correction amount C1 is not adjusted by the offset value ofs. The display processing device 30 sets the display position of the virtual image Iv to “reference position P0+offset value ofs+correction amount C1”.

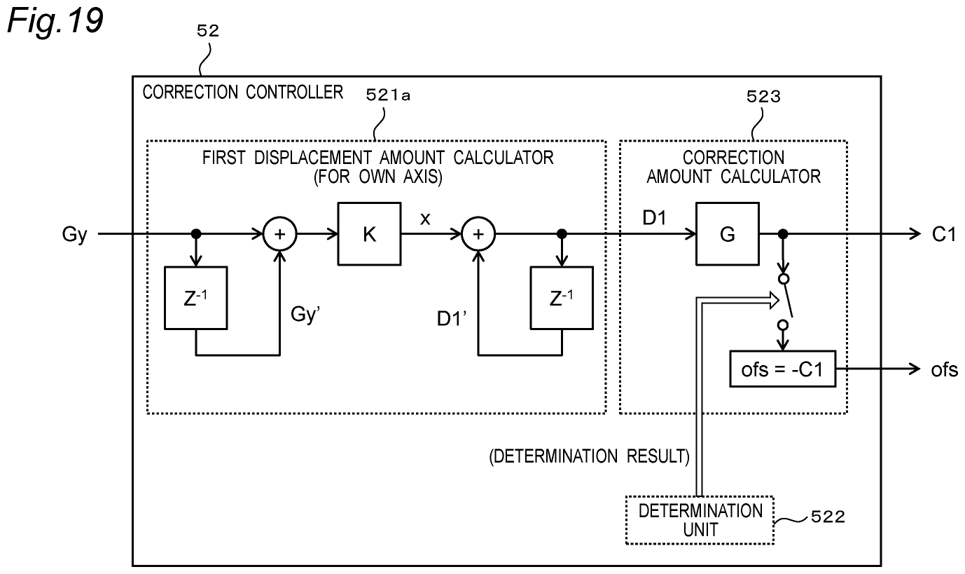

FIG. 17 shows the display processing performed by the display controller 32 of the display processing device 30. Steps S301 to S304, S307, and S308 of FIG. 17 of a second embodiment are the same as Steps S101 to S104, S107, and S108 of FIG. 11 of the first embodiment.

In the present embodiment, when displaying the virtual image, the display controller 32 acquires the offset value ofs together with the correction amount C1 from the correction processing device 50 (S305). The display controller 32 causes the projection device 10 to display the virtual image Iv based on the reference position P0, the offset value ofs, and the correction amount C1 (S306). Specifically, the display controller 32 sets a new reference position P0′ from “PO′−P0+ofs” from the reference position P0 and the offset value ofs. The reference position P0 before being adjusted by the offset value ofs is also referred to as an initial position. The offset value ofs corresponds to a shift amount from the initial position. The display controller 32 sets the display position of the virtual image Iv to “new reference position P0′+correction amount C1” and causes the projection device 10 to display the virtual image Iv.

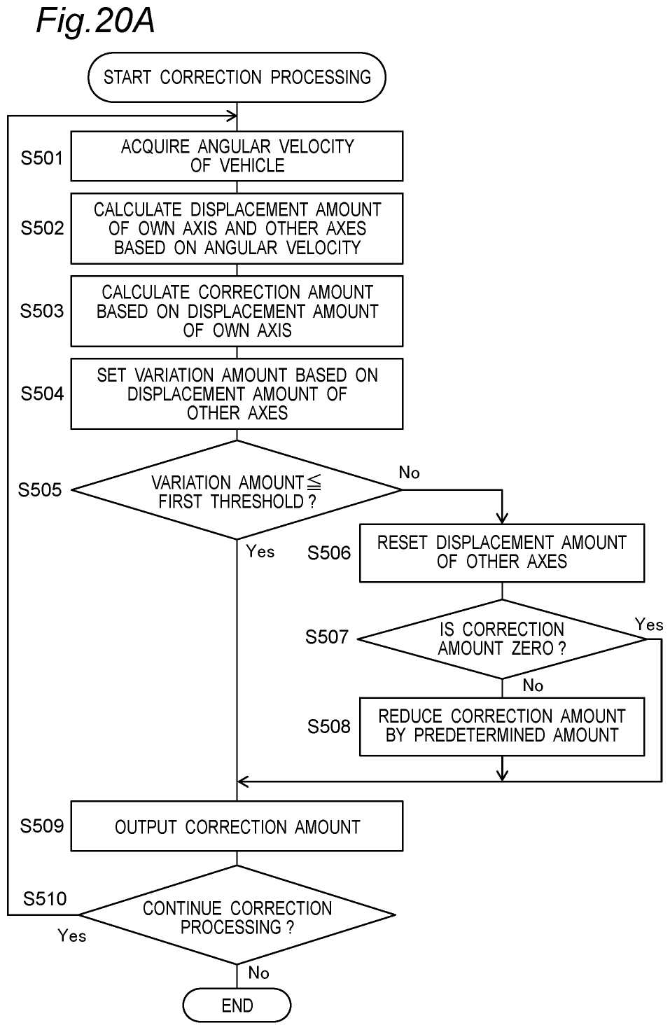

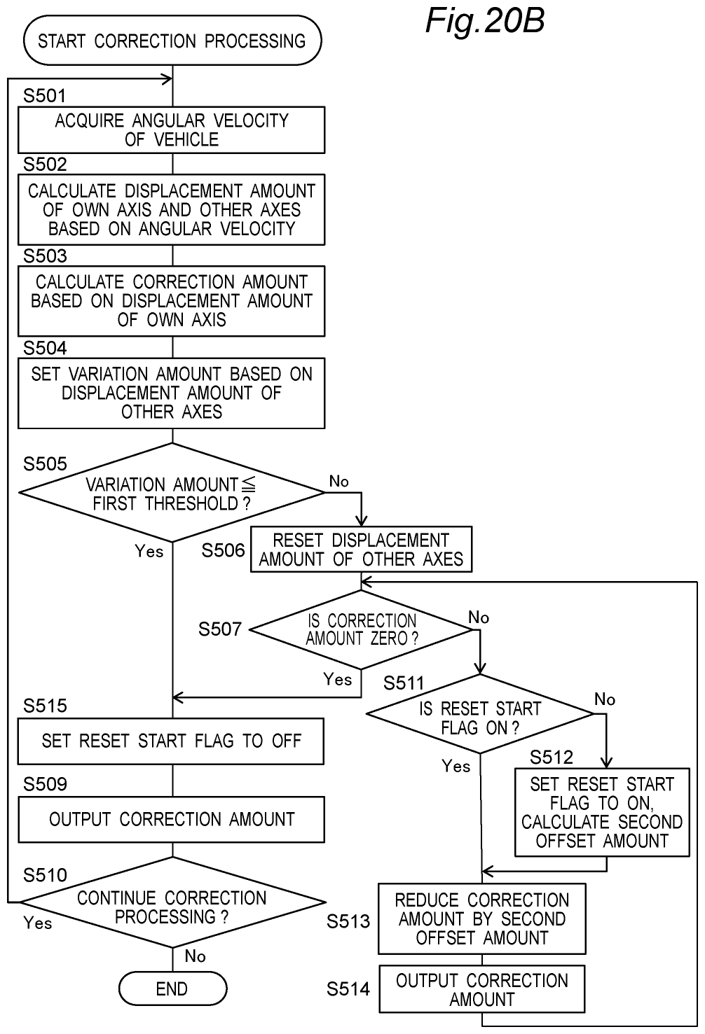

The operation of the correction controller 52 of the correction processing device 50 according to a second embodiment will be described with reference to FIGS. 18 and 19. FIG. 18 shows the correction processing performed by the correction controller 52 of the correction processing device 50. Steps S401, S402, S404, S405, S407, and S409 of FIG. 18 of the second embodiment are the same as steps S201, S202, S204, S205, S207, and S209 of FIG. 12 of the first embodiment. FIG. 19 shows the functional configuration of the correction controller 52 in the second embodiment.

In the present embodiment, the correction amount calculator 523 calculates the correction amount C1 from “C1=D1×G” based on the displacement amount D1 (S403).

The correction amount calculator 523 sets the offset value ofs based on the correction amount C1 when the variation amount A is larger than the first threshold a (ofs=−C1) (S406). The offset value ofs in the present embodiment corresponds to the number of pixels. An initial value of the offset value ofs is, for example, zero.

The correction amount calculator 523 outputs the correction amount C1 calculated in Step S403 and the offset value ofs set in Step S406 to the display processing device 30 (S408).

As described above, in the present embodiment, the display processing device 30 controls the display position of the image based on the reference position P0, the offset value ofs, and the correction amount C1. The correction processing device 50 sets the offset value ofs based on the correction amount C1 when the variation amount A is larger than the first threshold a.

By setting the offset value ofs based on the correction amount C1 of when the variation amount A is larger than the first threshold a, the display position based on the new reference position P0′ (=P0+ofs) and the correction amount C1 by the display controller 32 is substantially the same as the display position of the first embodiment. Therefore, according to the present embodiment, an effect that is the same as that of the first embodiment can be obtained.

### Third Embodiment

In the first embodiment, the correction controller 52 resets the correction amount C1 to zero when the variation amount A is larger than the first threshold a. In the present embodiment, the correction controller 52 reduces the magnitude of the correction amount C1 by a predetermined amount when the variation amount A is larger than the first threshold a.

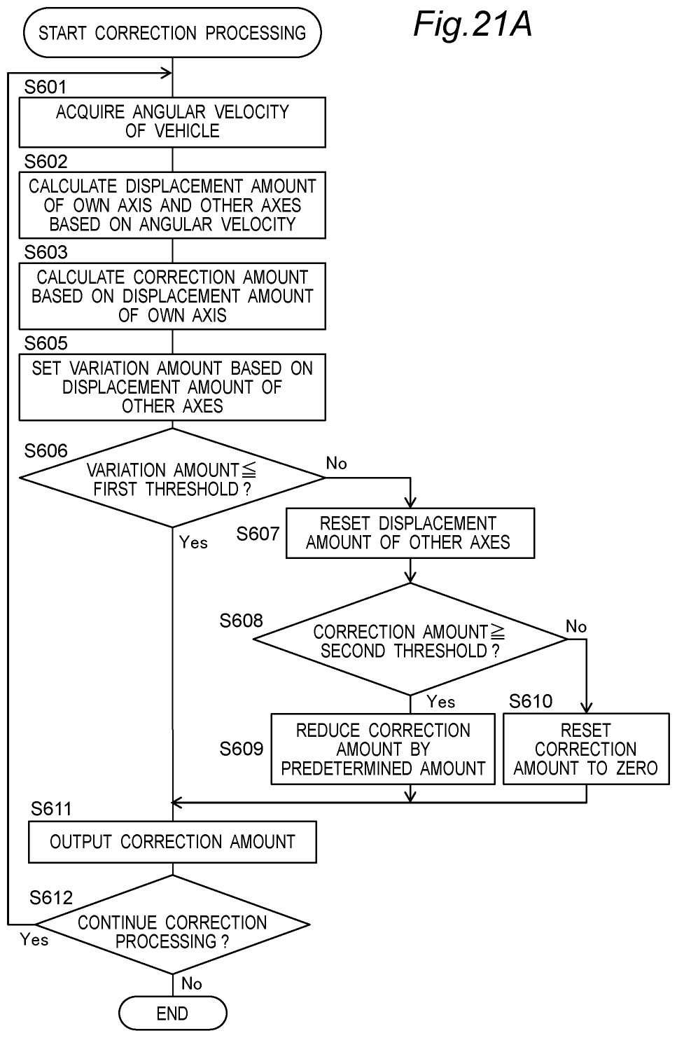

FIG. 20A shows correction processing performed by the correction controller 52 of the correction processing device 50 in a third embodiment. FIG. 20A of the third embodiment, Steps S507 and S508 are different from Step S206 of FIG. 12 of the first embodiment. The other steps are substantially the same.

The correction controller 52 calculates the correction amount C1 of the display position of the virtual image Iv based on the displacement amount D1 of the own axis from, for example, “C1=D1×G” (S503). In a case where the determination unit 522 determines that the variation amount A is larger than the first threshold a (No in S505), the second displacement amount calculator 521b and the third displacement amount calculator 521c reset the displacement amounts D2 and D3 to zero (S506). The correction amount calculator 523 determines whether or not the correction amount C1 calculated in Step S503 is zero (S507). Note that the determination unit 522 may determine whether or not the correction amount C1 is zero.

If the correction amount C1 is not zero (No in Step S507), the correction amount calculator 523 reduces the magnitude of the correction amount C1 by a predetermined amount so that the correction amount C1 approaches zero (S508). For example, the correction amount calculator 523 subtracts a predetermined amount qₚₓ from the correction amount C1 calculated in Step S503, and outputs “C1−qₚₓ” in Step S509. In another example, the correction amount calculator 523 may subtract a predetermined amount q_{deg} from the displacement amount D1 and calculate the correction amount C1 from “C1=(D1−q_{deg})×G”. In yet another example, the correction amount calculator 523 may set the predetermined amount q_{deg} as the offset value ofs in the calculation of the correction amount C1 shown in FIG. 13. The correction amount calculator 523 may set the predetermined amount qₚₓ as the offset value ofs in the calculation of the correction amount C1 shown in FIG. 15. The predetermined amounts qₚₓ and q_{deg} may be set according to the magnitude of the displacement amount D1 or the correction amount C1. For example, the predetermined amount qₚₓ is set to a value smaller than the correction amount C1 so that the correction amount C1 becomes a value larger than zero. The magnitude of the predetermined amounts qₚₓ and g_{deg} may be set according to the display position of the virtual image Iv in the display area 220. If the correction amount C1 is zero (Yes in Step S507), the processing proceeds to Step S509 without executing Step S508.

The correction amount calculator 523 outputs the correction amount C1 calculated in Step S503 or the correction amount C1 calculated in Step S508 to the display processing device 30 (S509).

As described above, the correction processing device 50 calculates the correction amount C1 for each sampling cycle of the correction processing, and reduces the correction amount C1 by a predetermined amount when the variation amount A is larger than the first threshold a. In this manner, the correction amount C1 is reduced by a certain amount while the correction amount C1 is updated to bring the display position closer to the reference position, so that the influence of the error due to the interference component of the other axes can be reduced. Further, since the correction amount is reduced only by the predetermined amount, the position of the virtual image Iv does not change abruptly. Therefore, it is possible to prevent the occupant D from feeling uncomfortable with the change in the display position of the virtual image Iv. That is, it is possible to suppress a feeling of uncomfortableness due to the shift of the display position. Furthermore, the accumulated error can also be reduced.

Next, a variation of the third embodiment will be described with reference to FIG. 20B. FIG. 20B shows the correction processing in the variation of the third embodiment. In the third embodiment, when the variation amount A is larger than the first threshold a, the correction amount C1 is reduced by a predetermined amount.

In the variation of the third embodiment, when the variation amount A is larger than the first threshold a, the correction amount C1 is gradually reset to zero over a certain period of time. Steps S501 to S507, S509, and S510 of FIG. 20B in the variation of the third embodiment are the same as those in the third embodiment.

In a case where the determination unit 522 determines that the variation amount A is larger than the first threshold a (No in S505), the second displacement amount calculator 521b and the third displacement amount calculator 521c reset the displacement amounts D2 and D3 to zero (S506). The correction amount calculator 523 determines whether or not the correction amount C1 is zero (S507).

If the correction amount C1 is not zero (No in Step S507), the correction amount calculator 523 determines whether or not the reset start flag is set to ON (S511). When the correction amount calculator 523 determines that the reset start flag is not set to ON (No in S511), the correction amount calculator 523 sets the reset start flag to ON and calculates a second offset amount ofs2 (S512). Next, the correction amount calculator 523 reduces the correction amount C1 by the calculated second offset amount ofs2 (S513). The correction amount calculator 513 outputs the reduced correction amount C1 to the display processing device 30 (S514).

Next, returning to Step S507, the correction amount calculator 523 determines again whether or not the correction amount C1 is zero. When the correction amount calculator 523 determines that the correction amount C1 is not zero (No in S507), the correction amount calculator 523 determines whether or not the reset start flag is set to ON. If the reset start flag is set to ON (Yes in S511), the correction amount C1 is reduced again by the offset amount ofs2 (S513). In this manner, the correction amount C1 is gradually reduced.

For example, if the reset start flag is set to ON at a time t1, the correction amount C1 gradually decreases while the reset start flag is set to ON, and the correction amount becomes zero at a time t4 that is after a reset time Δt1 from the time t1. The second offset amount ofs2 may be a predetermined value or may be determined by calculation. For example, the configuration may be such that the reset time Δt1 is set in advance, the second offset amount ofs2 in one sampling (one cycle from S507 to S514 in the flowchart) is set to c1×ts/Δt1 from a sampling period ts and the correction amount C1 at the start of resetting, and the correction amount is reduced by c1×ts/Δt1 at a time.

When the correction amount C1 becomes zero, the correction amount calculator 523 determines that the correction amount C1 is zero in the determination in Step S507 (Yes in S507), and sets the reset start flag to OFF (S515). In a case where the variation amount A is more than the first threshold a, the correction amount calculator 523 outputs the correction amount C1 which is repeatedly reduced to zero in Steps S507 to S514 to the display processing device 30 (S509).

As described above, the correction processing device 50 gradually reduces the correction amount C1 over a certain period of time when the variation amount A is larger than the first threshold a, so that the position of the virtual image Iv gradually returns to the reference position P0. Since the position of the virtual image Iv does not suddenly change significantly, it is possible to prevent the occupant D from feeling uncomfortable with the change in the display position of the virtual image Iv. That is, it is possible to suppress a feeling of uncomfortableness due to the shift of the display position.

### Fourth Embodiment

When the variation amount A is larger than the first threshold a, the correction amount C1 is reset to zero in the first embodiment, and the magnitude of the correction amount C1 is reduced by the predetermined amount in the third embodiment. In the present embodiment, the correction amount C1 is adjusted according to the magnitude of the correction amount C1 calculated from the displacement amount D1. Specifically, in a case where the correction amount C1 is equal to or more than a second threshold b, the correction amount C1 is reduced by a predetermined amount, and when the correction amount C1 is less than the second threshold b, the correction amount Cl is reset to zero. The second threshold b is a threshold for the correction amount.

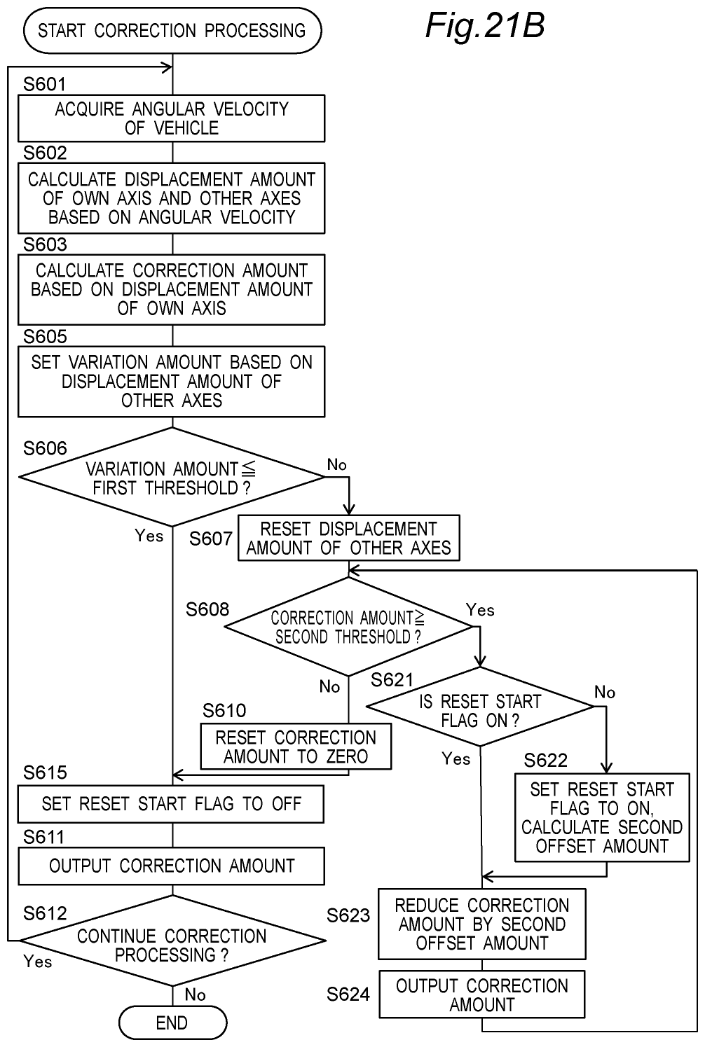

FIG. 21 shows the correction processing in a fourth embodiment. FIG. 21 of the fourth embodiment is a combination of FIG. 12 of the first embodiment and FIG. 20 of the third embodiment.

In the present embodiment, in a case where the variation amount A is larger than the first threshold a (No in S606), the second displacement amount calculator 521b and the third displacement amount calculator 521c reset the displacement amounts D2 and D3 to zero (S607). The correction amount calculator 523 determines whether or not the correction amount C1 based on the displacement amount calculated in Step S603 is equal to or more than the second threshold b (S608). The determination unit 522 may make the determination in Step S608.

If the correction amount C1 is equal to or more than the second threshold b (Yes in Step S608), the correction amount calculator 523 reduces the correction amount C1 by a predetermined amount (S609).

If the correction amount C1 is smaller than the second threshold b (No in Step S608), the correction amount calculator 523 resets the correction amount C1 to zero (S610).

As described above, the correction processing device 50 calculates the correction amount C1 for each sampling cycle of the correction processing. In a case where the variation amount A is larger than the first threshold a, the correction processing device 50 reduces the correction amount C1 by a predetermined amount so that the correction amount C1 approaches zero when the correction amount C1 is equal to or more than the second threshold b, and resets the correction amount C1 to zero when the correction amount C1 is smaller than the second threshold b. As described above, the correction amount is reduced by a certain amount while the correction amount C1 is updated, and when reduced to a certain degree, the correction amount C1 is reset to zero. In this manner, correction of the display position can be performed according to the inclination of the posture of the vehicle 200 without making the appearance unnatural.

Next, a variation of the fourth embodiment will be described with reference to FIG. 21B. FIG. 21B shows the correction processing in the variation of the fourth embodiment. In the fourth embodiment, in the case where the variation amount A is larger than the first threshold a, when the correction amount C1 is equal to or more than the second threshold b, the correction amount calculator 523 reduces the correction amount C1 by a predetermined amount. In the variation of the fourth embodiment, from the time when the correction amount calculation unit 523 determines that the variation amount A is larger than the first threshold a, the correction amount C1 is gradually reduced in a case where the correction amount C1 is equal to or more than the second threshold b, and the correction amount is reset to zero in a case where the correction amount C1 is less than the second threshold b.

Steps S601 to S603, S605 to S608, and S610 to S612 of FIG. 21B in the variation of the fourth embodiment are the same as those in the fourth embodiment. Further, Steps S615 and S621 to S624 of FIG. 21B in the variation of the fourth embodiment are the same as Steps S515 and S511 to S514 of FIG. 20B in the variation of the third embodiment, respectively.

In the variation of the fourth embodiment, in a case where the variation amount A is larger than the first threshold a (No in S606), the second displacement amount calculator 521b and the third displacement amount calculator 521c reset the displacement amounts D2 and D3 to zero (S607). The correction amount calculator 523 determines whether or not the correction amount C1 based on the displacement amount calculated in Step S603 is equal to or more than the second threshold b (S608).

If the correction amount C1 is equal to or more than the second threshold b (Yes in Step S608), the correction amount calculator 523 determines whether or not the reset start flag is set to ON (S621). When the correction amount calculator 523 determines that the reset start flag is not set to ON (No in S621), the correction amount calculator 523 sets the reset start flag to ON and calculates the second offset amount ofs2 (S622). Next, the correction amount calculator 523 reduces the correction amount C1 by the calculated second offset amount ofs2 (S623). The correction amount calculator 523 outputs the reduced correction amount C1 to the display processing device 30 (S624).

Next, returning to step 608, the correction amount calculator 523 again determines whether or not the correction amount C1 is equal to or more than the second threshold b. When the correction amount calculator 523 determines that the correction amount C1 is equal to or more than the second threshold b (Yes in S608), the correction amount calculator 523 determines whether or not the reset start flag is set to ON (S621). If the reset start flag is set to ON (Yes in S621), the correction amount C1 is reduced again by the second offset amount ofs2 (S623). In this manner, when the correction amount C1 is gradually reduced and the correction amount C1 becomes less than the second threshold b, the correction amount calculator 523 determines that the correction amount C1 is less than the second threshold b in the determination in Step S608 (No in S608), and the correction amount calculator 523 resets the correction amount C1 to zero (S610). After that, the correction amount calculator 523 sets the reset start flag to OFF (S615).

For example, if the reset start flag is set to ON at the time t1, the correction amount C1 gradually decreases while the reset start flag is set to ON, and the correction amount C1 becomes less than the second threshold b at a time t5 that is after a reset time Δt2 from the time t1. The second offset amount ofs2 may be a predetermined value or may be determined by calculation. For example, the configuration may be such that the reset time Δt2 is set in advance, a second offset amount in one sampling (one cycle from S608 to S624 in the flowchart) is set to (C1−b)×ts/Δt2 from the sampling period ts and the correction amount c1 at the start of resetting, and the correction amount is reduced by (C1−b)×ts/Δt2 at a time.

As described above, in a case where the variation amount A is larger than the first threshold a, the correction processing device 50 reduces the correction amount C1 by a certain amount at a time so that the correction amount C1 approaches zero when the correction amount C1 is equal to or more than the second threshold b, and resets the correction amount C1 to zero when the correction amount C1 is smaller than the second threshold b. In this manner, it is possible to perform the correction of the display position and the elimination of the accumulated error without causing any visual discomfort.

### Fifth Embodiment

In the first to fourth embodiments, the variation amount A is set based on the displacement amounts D2 and D3 of the other axes. In the present embodiment, the variation amount A is set based on correction amounts C2 and C3 calculated from the displacement amounts D2 and D3 of the other axes. That is, in the present embodiment, a timing of resetting of the correction amount C1 of the own axis is controlled based on the number of pixels indicated by the correction amounts C2 and C3. The method of calculating and resetting the correction amount C1 of the own axis is the same as that in the first to fourth embodiments.

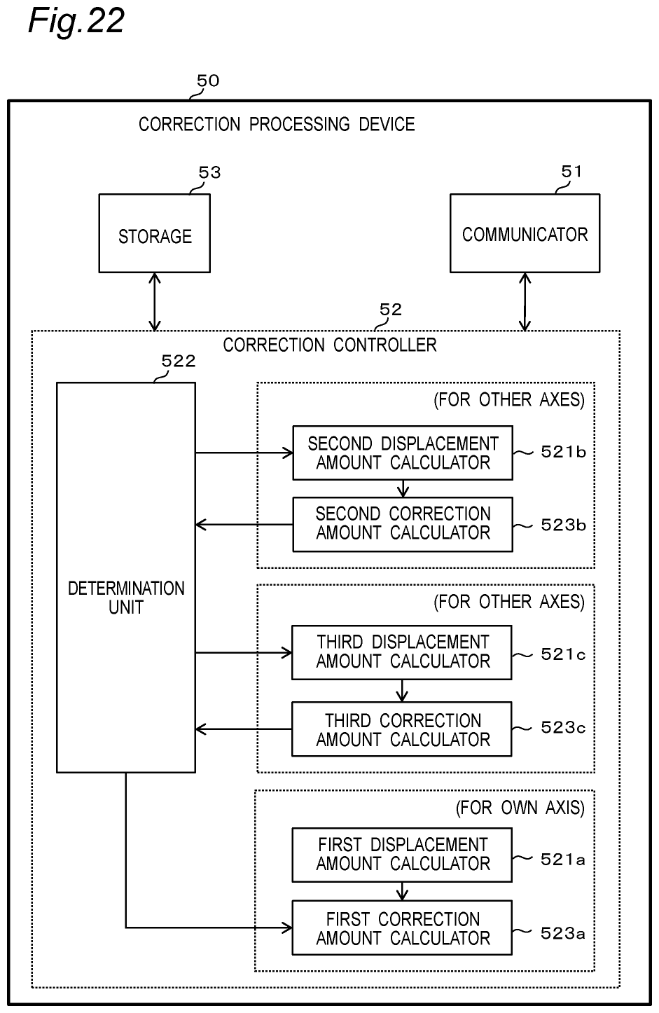

FIG. 22 shows an internal configuration of the correction processing device 50 in a fifth embodiment. A first correction amount calculator 523a for the own axis of FIG. 22 corresponds to the correction amount calculator 523 of FIG. 2. In the present embodiment, the correction controller 52 further includes a second correction amount calculator 523b and a third correction amount calculator 523c for calculating the correction amounts C2 and C3 of the other axes.

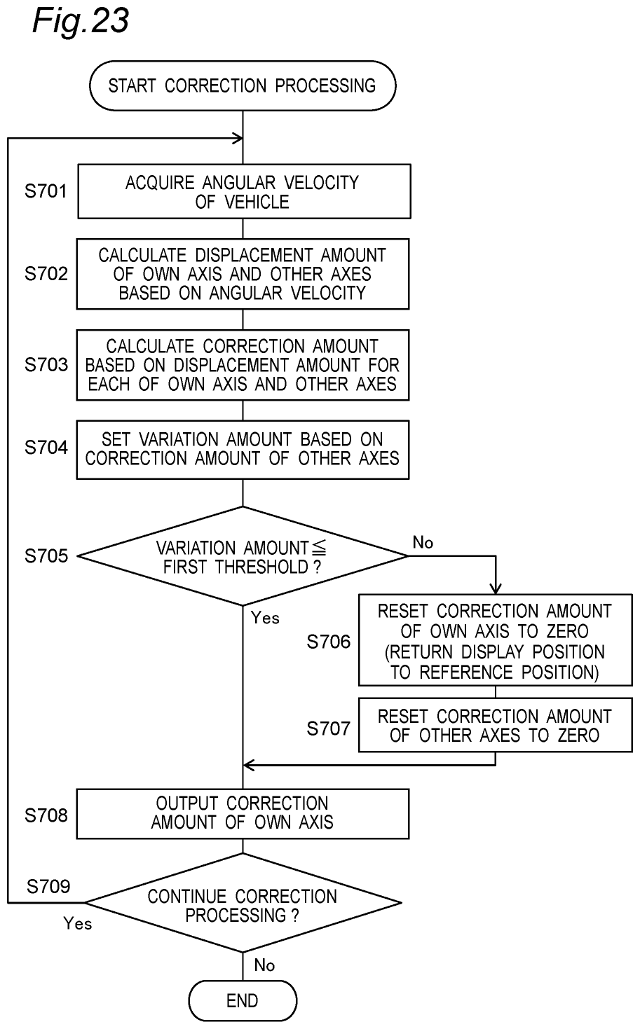

FIG. 23 shows correction processing performed by the correction controller 52 of the correction processing device 50 in the fifth embodiment. Steps S701, S702, S706, S708, and S709 of FIG. 23 of the fifth embodiment are the same as Steps S201, S202, S206, S208, and S209 of FIG. 12 of the first embodiment.

In the present embodiment, the first to third correction amount calculators 523a, 523b, and 523c calculate the correction amounts C1, C2, and C3 based on the displacement amounts D1, D2, and D3, respectively (S703). The calculation of the correction amount C1 of the own axis is, for example, the same as that in the first embodiment. The second correction amount calculation unit 523b and the third correction amount calculation unit 523c for the other axes calculate the correction amounts C2 and C3 by, for example, multiplying the displacement amounts D2 and D3 by a conversion coefficient G for converting an angle to the number of pixels, and from “C2=D2×G” and “C3=D3×G”.

The determination unit 522 sets the variation amount A based on the correction amounts C2 and C3 of the other axes (S704). In the present embodiment, the variation amount A is a larger one of the correction amount C2 and the correction amount C3.

Note that the variation amount A may be the correction amount C2 or the correction amount C3. The variation amount A may be calculated by operation, for example, from Equation (2).

[Equation 2]

A=\sqrt{C2²+C3²} (2)

The determination unit 522 compares the variation amount A with the first threshold a (S705). When the variation amount A is larger than the first threshold a (No in S705), the first correction amount calculation unit 523a resets the correction amount C1 of the own axis to zero (S706) and the second correction amount calculation unit 523b and the third correction amount calculation unit 523c reset the correction amounts C2 and C3 for the other axes to zero (S707). For example, as shown in FIG. 14, when the second displacement amount calculation unit 521b outputs the displacement amount D2 that is zero based on x=0 and D2′=0, the second correction amount calculation unit 523b resets the correction amount C2 to zero from “C2=0×G”. The third displacement amount calculation unit 521c can also reset the correction amount C3 to zero by a similar method.

As described above, the correction processing device 50 resets the correction amount C1 to zero when an inclination amount of the posture of the moving body calculated from the angular velocities of the other axes is larger than the first threshold a. In the present embodiment, the inclination amount of the posture of the moving body is the variation amount A set based on the correction amounts C2 and C3. That is, in the present embodiment, the inclination amount of the posture is represented by the number of pixels. In the present embodiment, an effect equivalent to that of the first embodiment can be obtained.

### Sixth Embodiment

In the first to fifth embodiments, the case where there is one axis to be corrected is described. In the present embodiment, a case where all of the pitch axis, yaw axis, and roll axis are axes to be corrected will be described.

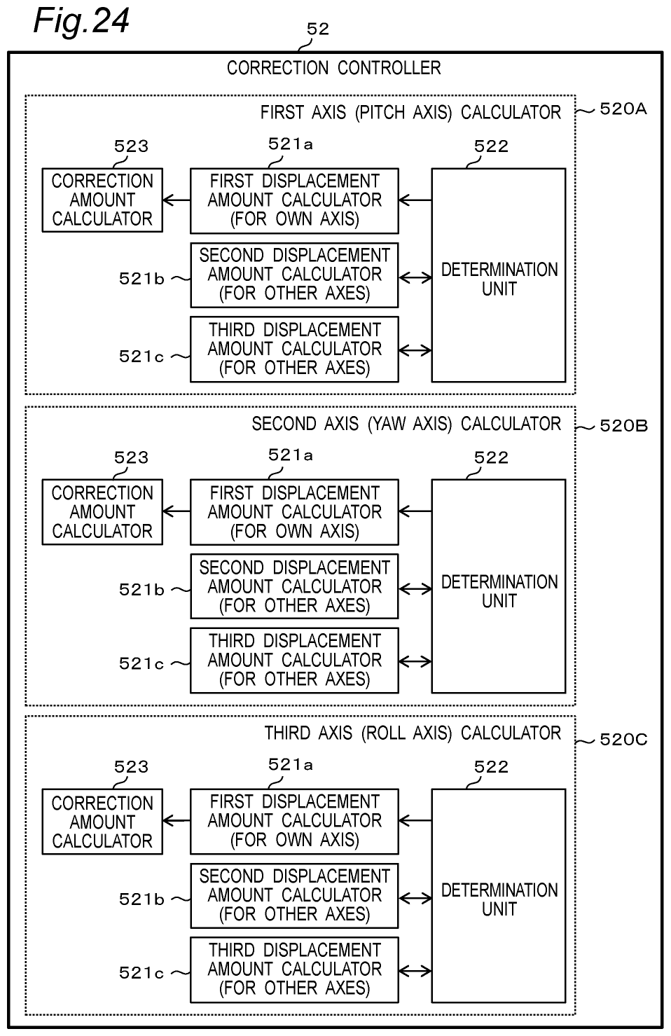

FIG. 24 shows the functional configuration of the correction controller 52 in a sixth embodiment. The correction controller 52 of the present embodiment includes a first axis calculation unit 520A, a second axis calculation unit 520B, and a third axis calculation unit 520C. The first axis calculation unit 520A, the second axis calculation unit 520B, and the third axis calculation unit 520C are, for example, for the pitch axis, the yaw axis, and the roll axis, respectively. The first axis calculation unit 520A, the second axis calculation unit 520B, and the third axis calculation unit 520C include the first displacement amount calculation unit 521a for the own axis, the second displacement amount calculation unit 521b and the third displacement amount calculation unit 521c for the other axes, the determination unit 522, and the correction amount calculation unit 523 shown in FIG. 2.

The method of calculating and resetting the displacement amounts D1, D2, and D3 of the own axis and the other axes, and the method of calculating and resetting the correction amounts C1, C2, and C3 of the own axis and the other axes are the same as those in the first to fifth embodiments. If the own axis is the pitch axis, the other axes are the yaw axis and the roll axis. If the own axis is the yaw axis, the other axes are the pitch axis and the roll axis. If the own axis is the roll axis, the other axes are the yaw axis and the pitch axis.

According to the present embodiment, it is possible to suppress the other axis interference component in a case where all the three axes are the axes to be corrected.

Note that, in the present embodiment, all the three axes are set as the axes to be corrected. However, the axes to be corrected may be two axes. In this case, the correction controller 52 preferably includes the first axis calculation unit 520A and the second axis calculation unit 520B. In the present embodiment, the case where there are two of the other axes with respect to the axis to be corrected is described. However, there may be one of the other axis with respect to the axis to be corrected. For example, the axes to be corrected may be the pitch axis and the roll axis, and the other axis may be the yaw axis. The axes to be corrected may be the pitch axis and the yaw axis, and the other axis may be the roll axis.

### Seventh Embodiment

In the first to sixth embodiments, when the variation amount A is larger than the first threshold a, the correction amount C1 of the own axis is reset to zero or reduced by a predetermined amount, so that the other axis interference component is suppressed. In the present embodiment, angular velocities Gx′, Gy′, and Gz′ obtained by removing the other axis interference component are calculated based on the angular velocities of the own axis and the other axes. That is, the original angular velocity in a case where the other axis interference is not received is calculated, and the displacement amount D1 of the own axis is calculated. In the present embodiment, the correction amount C1 is not reset. In the present embodiment, as shown in FIGS. 8B and 9B, it is possible to reduce other axis interference caused by the attaching error of the gyro sensor 41.

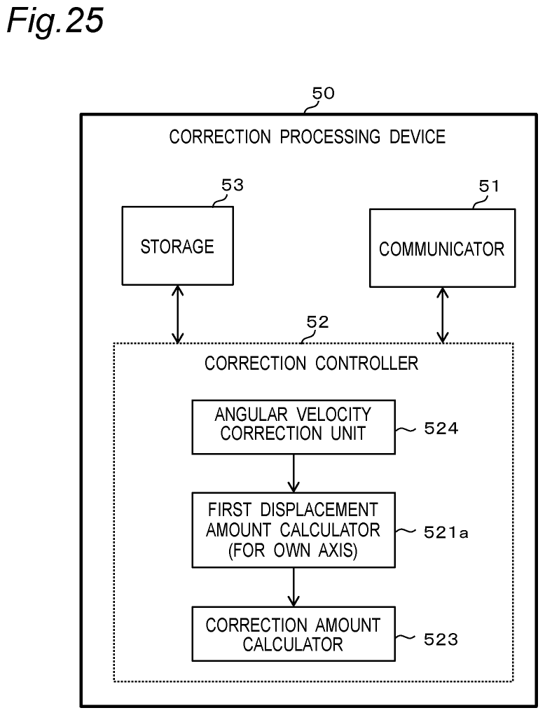

FIG. 25 shows an internal configuration of the correction processing device 50 of a seventh embodiment. In the present embodiment, the correction controller 52 includes an angular velocity correction unit 524, the first displacement amount calculation unit 521a for the own axis, and the correction amount calculation unit 523. The angular velocity correction unit 524 calculates the angular velocities Gx′, Gy′, and Gz′ obtained by removing the other axis interference component based on the angular velocities of the own axis and the other axes. The operation of the first displacement amount calculation unit 521a and the correction amount calculation unit 523 is substantially the same as that of the first to sixth embodiments. That is, the first displacement amount calculation unit 521a calculates the displacement amount D1 from the angular velocity. The correction amount calculation unit 523 converts the displacement amount D1 to the number of pixels to calculate the correction amount C1.

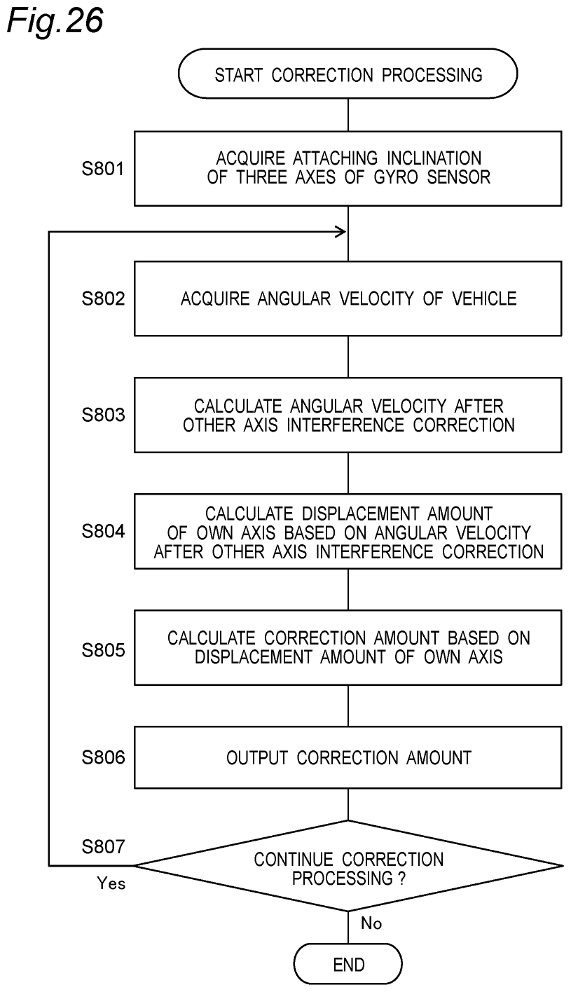

FIG. 26 shows correction processing performed by the correction controller 52 of the correction processing device 50 in the seventh embodiment. The angular velocity correction unit 524 acquires data indicating the inclinations θ, α, and β around the roll axis, the pitch axis, and the yaw axis in a case where the gyro sensor 41 is attached in an inclined manner as shown in FIG. 8B from, for example, the posture detection device 40 (S801). The angular velocity correction unit 524 acquires the angular velocity information indicating the angular velocities Gx, Gy, and Gz of the vehicle 200 output from the gyro sensor 41 (S802). The angular velocity correction unit 524 calculates the angular velocities Gx′, Gy′, and Gz′ after other axis interference correction based on the inclinations θ, α, and β and the angular velocities Gx, Gy, and Gz (S803).

A relationship between the detected angular velocities Gx, Gy, and Gz and the angular velocities Gx′, Gy′, and Gz′ in a case where there is no other axis interference is as shown in Equation (3).

$$\begin{matrix} [ Equation 3 ] & \\ ( \begin{matrix}Gx \\ Gy \\ Gz\end{matrix} ) = ( \begin{matrix}cos β & sin β & 0 \\ - sin β & cos β & 0 \\ 0 & 0 & 1\end{matrix} ) ( \begin{matrix}cos α & 0 & - sin α \\ 0 & 1 & 0 \\ sin α & 0 & cos α\end{matrix} ) ( \begin{matrix}1 & 0 & 0 \\ 0 & cos θ & sin θ \\ 0 & - sin θ & cos θ\end{matrix} ) ( \begin{matrix}{Gx}^{′} \\ {Gy}^{′} \\ {Gz}^{′}\end{matrix} ) & ( 3 )\end{matrix}$$

Here, a rotation matrix R is defined as in Equation (4).

$$\begin{matrix}[ Equation 4 ] & \\ R = ( \begin{matrix}cos β & sin β & 0 \\ - sin β & cos β & 0 \\ 0 & 0 & 1\end{matrix} ) ( \begin{matrix}cos α & 0 & - s in α \\ 0 & 1 & 0 \\ sin α & 0 & cos α\end{matrix} ) ( \begin{matrix}1 & 0 & 0 \\ 0 & cos θ & sin θ \\ 0 & - sin θ & cos θ\end{matrix} ) & ( 4 )\end{matrix}$$

Equation (5) can be derived from Equation (3) and Equation (4). Here, R⁻¹ is an inverse matrix of R.

$$\begin{matrix}[ Equation 5 ] & \\ ( \begin{matrix}{Gx}^{′} \\ {Gy}^{′} \\ {Gz}^{′}\end{matrix} ) = {R}^{- 1} ( \begin{matrix}Gx \\ Gy \\ Gz\end{matrix} ) & ( 5 )\end{matrix}$$

The inverse matrix R⁻¹ is as shown in Equation (6).

$$\begin{matrix} [ Equation 6 ] & \\ {R}^{- 1} = ( \begin{matrix}\begin{matrix}cos α cos β + \\ \frac{1}{4} sin 2 θ sin 2 α sin β\end{matrix} & - cos αsin β & sin α \\ cos θ sin β + sin θ sin α cos β & cos θ cos β - sin θ sin α sin β & - sin θ cos α \\ sin θ sin β - cos θ sin α cos β & sin θ cos β + cos θ sin α sin β & cos θ cos α\end{matrix} ) & ( 6 )\end{matrix}$$

Therefore, Equation (7) is derived by replacing the inverse matrix R⁻¹ of Equation (5) with Equation (6).

$$\begin{matrix} [ Equation 7 ] & \\ ( \begin{matrix}{Gx}^{′} \\ {Gy}^{′} \\ {Gz}^{′}\end{matrix} ) = ( \begin{matrix}\begin{matrix}cos α cos β + \\ \frac{1}{4} sin 2 θ sin 2 α sin β\end{matrix} & - cos αsin β & sin α \\ cos θ sin β + sin θ sin α cos β & cos θ cos β - sin θ sin α sin β & - sin θ cos α \\ sin θ sin β - cos θ sin α cos β & sin θ cos β + cos θ sin α sin β & cos θ cos α\end{matrix} ) ( \begin{matrix}Gx \\ Gy \\ Gz\end{matrix} ) & ( 7 )\end{matrix}$$

The angular velocity correction unit 524 calculates the angular velocities Gx′, Gy′, and Gz′ after the other axis interference correction from Equation (7) based on the inclinations 8, a, and p and the angular velocities Gx, Gy, and Gz acquired from the gyro sensor 41.

The first displacement amount calculation unit 521a calculates the displacement amount D1 of the own axis based on the angular velocity after the other axis interference correction (S804). For example, in a case where the own axis is the pitch axis, the first displacement amount calculation unit 521a calculates the displacement amount D1 based on the angular velocity Gy′ after the other axis interference correction. The correction amount calculation unit 523 converts the displacement amount D1 to the number of pixels to calculate the correction amount C1 (S805). The correction amount calculation unit 523 outputs the calculated correction amount C1 to the display processing device 30 (S806). The correction controller 52 determines whether or not to continue the correction processing (S807). In a case where the correction processing is continued (Yes in S807), the processing returns to Step S802. In a case where the correction processing is not continued (No in S807), the processing shown in FIG. 26 is finished.

As described above, in the present embodiment, the correction processing device 50 calculates the angular velocities Gx′, Gy′, and Gz′ after the other axis interference correction based on the inclination θ, α, and β which are the attaching angles of the gyro sensor 41 to the vehicle 200 and the angular velocities Gx, Gy, and Gz detected by the gyro sensor 41. That is, the magnitude of only the posture variation of the own axis when the posture variation of the other axes does not interfere is calculated. In this manner, even in a case where the interference due to the posture variation of the other axes caused by the attaching error of the gyro sensor 41 is generated, the correction amount C1 is calculated based on the angular velocity after the other axis interference correction, so that it is possible to accurately suppress the displacement of the display position of the image.

### Eighth Embodiment

The first to seventh embodiments describe the display system 100 that displays a virtual image in front of the windshield of the vehicle 200. However, the correction of the display position of the image according to the present disclosure may be realized by a single device without limitation to the display system 100 including a plurality of devices.

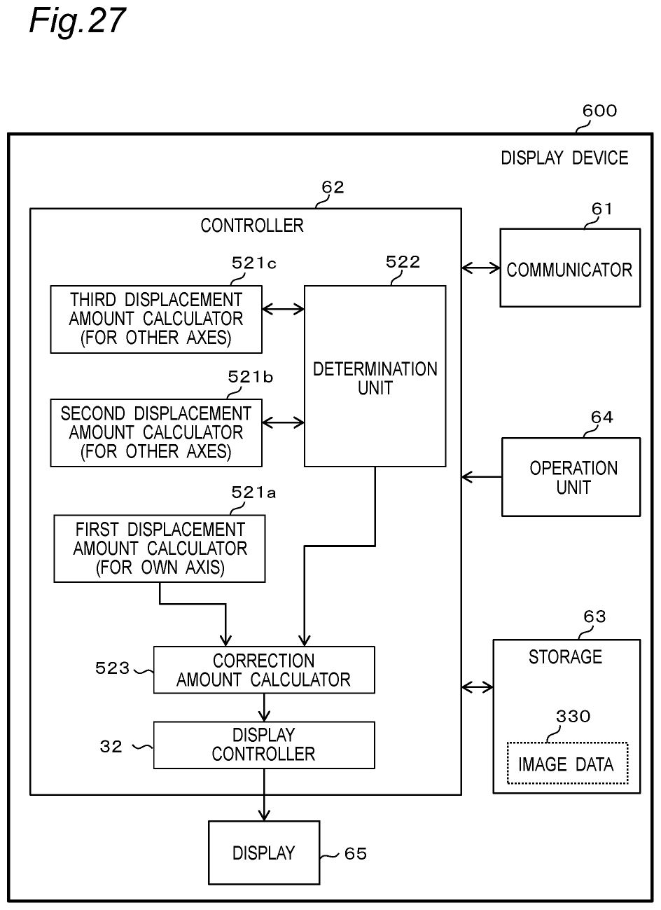

FIG. 27 shows a configuration of a display device in an eight embodiment. A display device 600 of the present embodiment is a device that displays an image according to, for example, the traveling of the vehicle 200. The display device 600 is, for example, various information processing devices such as a personal computer, a tablet terminal, a smartphone, and the like. The display device 600 corresponds to, for example, a device in which the display processing device 30 and the correction processing device 50 of the display system 100 in FIG. 2 are integrally formed.

The display device 600 includes a communicator 61, a controller 62, a storage 63, an operation unit 64, and a display unit 65.

The communicator 61 has a function or a structure equivalent to that of the communicator 31 or the communicator 51.

The controller 62 has a function or a structure equivalent to that of the display controller 32 and the correction controller 52. Specifically, the controller 62 includes the first displacement amount calculation unit 521a, the second displacement amount calculation unit 521b, the third displacement amount calculation unit 521c, the determination unit 522, the correction amount calculation unit 523, and the display controller 32. The first displacement amount calculation unit 521a, the second displacement amount calculation unit 521b, the third displacement amount calculation unit 521c, the determination unit 522, the correction amount calculation unit 523, and the display controller 32 of the present embodiment correspond to the first displacement amount calculation unit 521a, the second displacement amount calculation unit 521b, the third displacement amount calculation unit 521c, the determination unit 522, the correction amount calculation unit 523, and the display controller 32 shown in FIG. 2, respectively.

The storage 63 corresponds to the storage 33 and the storage 53, and stores the image data 330.

The operation unit 64 is a user interface for inputting various operations by the user. For example, the operation unit 64 is a touch panel provided on the surface of the display unit 65. The operation unit 64 may be realized by a keyboard, a button, a switch, or a combination of these, other than the touch panel.

The display unit 65 is composed of, for example, a liquid crystal display or an organic EL display. The display unit 65 displays, for example, an image indicated by the image data 330 at the display position indicated by “reference position P0+correction amount C1” designated by the display controller 32.

The display device 600 may be connected to a projector or may be incorporated in a projector. The display unit 65 may include a function or a structure equivalent to that of the projection device 10.

As described above, the display device 600 includes the acquisition unit, the display unit 65, and the controller 62. For example, the communicator 61 corresponds to the acquisition unit that acquires posture variation information that indicates a first posture variation of the moving body having the first axis as the rotation axis and a second posture variation of the moving body having the second axis orthogonal to the first axis as the rotation axis. The display unit 65 displays an image at the display position based on the reference position and the correction amount. The controller 62 sets the correction amount based on the magnitude of the first posture variation. In the setting of the correction amount, the controller 62 corrects the interference of the second posture variation with respect to the magnitude of the first posture variation based on the magnitude of the second posture variation.

According to the present embodiment, an effect equivalent to that of the first embodiment can be obtained.

### Other Embodiments

As described above, the first to eighth embodiments have been described as an example of the technique disclosed in the present application. However, the technique in the present disclosure is not limited to this, and is also applicable to an embodiment in which changes, replacements, additions, omissions, and the like are appropriately made. Further, the constituents described in the first to eighth embodiments can also be combined to form a new embodiment. In view of the above, other embodiments will be exemplified below.

The above embodiment describes the example in which the information acquisition device 20 includes the GPS module 21 and the camera 22. However, the information acquisition device 20 may include a distance sensor that measures a distance and a direction from the vehicle 200 to a surrounding object, and may output distance information indicating the measured distance and direction to the display processing device 30. The information acquisition device 20 may include a vehicle speed sensor that detects the speed of the vehicle 200. The information acquisition device 20 may include a navigation system. The information acquisition device 20 may include one or more of the GPS module 21, a distance sensor, the camera 22, an image processing device, an acceleration sensor, a radar, a sound wave sensor, and a white line detection device of advanced driver-assistance systems (ADAS). The GPS module 21, the distance sensor, the camera 22, the vehicle speed sensor, and the like having a function as the information acquisition device 20 may be built in one device or individually attached to the vehicle 200.

The above embodiment describes the example in which the posture detection device 40 includes the gyro sensor 41. However, the posture detection device 40 may include an acceleration sensor that detects the acceleration of the vehicle 200, and may output the detected acceleration as the posture variation information. The posture detection device 40 may include a vehicle height sensor that detects the height from the road surface, and may output the detected height as the posture variation information. The posture detection device 40 may include other publicly-known sensors. The posture detection device 40 may include one or more of the gyro sensor 41, the acceleration sensor, the vehicle speed sensor, and the like. In this case, the gyro sensor 41 having the function of the posture detection device 40, the acceleration sensor, the vehicle height sensor, and the like may be built in one device or individually attached to the vehicle 200.

The first to seventh embodiments illustrate the case where the projection device 10, the information acquisition device 20, the display processing device 30, the posture detection device 40, and the correction processing device 50 are separate devices. However, a plurality of devices may be integrally formed as one device. For example, the display processing device 30 and the correction processing device 50 may be integrally formed as one device. The information acquisition device 20 and the display processing device 30 may be integrally formed as one device. The posture detection device 40 and the correction processing device 50 may be integrally formed as one device. The separately formed devices are connected in a manner communicable with each other by wire or wirelessly. Note that all the projection device 10, the information acquisition device 20, the display processing device 30, the posture detection device 40, and the correction processing device 50 may be formed as one device. In this case, the communicators 31 and 51 may be omitted.

The above embodiment describes the case where the moving body is the vehicle 200 such as an automobile. However, the moving body is not limited to the vehicle 200. The moving body may be a vehicle on which a person rides, and may be, for example, an airplane or a ship. The moving body may be an unmanned moving body. The moving body may be one that vibrates instead of one that travels.

The first to seventh embodiments describe the examples in which the display system 100 is an HUD system. However, the display system 100 does not need to be an HUD system. The display system 100 may include a liquid crystal display or an organic EL display instead of the projection device 10. Display system 100 may include a screen and a projector.

The above embodiment describes the case where the image is displayed in front of the moving body. However, the position where the image is displayed is not limited to the front. For example, the image may be displayed in the side direction or in the rear of the moving body.

### Summary of Embodiment

(1) A display system of the present disclosure includes a detection device that detects a first posture variation of a moving body having a first axis as a rotation axis, a display processing device that controls a display position of an image based on a reference position and a correction amount, and a correction processing device that sets the correction amount based on magnitude of the first posture variation. The detection device detects a second posture variation of the moving body having a second axis orthogonal to the first axis as a rotation axis, and the correction processing device corrects interference of the second posture variation with respect to magnitude of the first posture variation based on magnitude of the second posture variation in setting of the correction amount.

In this manner, even in a case where interference is generated due to the posture variation of the other axes, it is possible to accurately suppress the position displacement of the image.

(2) In the display system of (1), the correction processing device corrects the interference of the second posture variation based on magnitude of the second posture variation by setting an inclination amount of a posture of the moving body with respect to the second axis based on the second posture variation, and resetting the correction amount to zero when the inclination amount of the posture is larger than a first threshold.

By resetting the correction amount to zero, the influence of the error due to the interference component of the other axes can be eliminated.

(3) In the display system of (1), the correction processing device corrects the interference of the second posture variation based on magnitude of the second posture variation by setting an inclination amount of a posture of the moving body with respect to the second axis based on the second posture variation, and reducing the correction amount by a predetermined amount so that the correction amount approaches zero when the inclination amount of the posture is larger than a first threshold.

By bringing the display position closer to the reference position, it is possible to reduce the influence of the error due to the interference component of the other axes.

(4) In the display system of (1), the correction processing device corrects the interference of the second posture variation based on magnitude of the second posture variation by setting an inclination amount of a posture of the moving body with respect to the second axis based on the second posture variation, and, in a case where the inclination amount of the posture is larger than a first threshold, reducing the correction amount by a predetermined amount so that the correction amount approaches zero when the correction amount is equal to or more than a second threshold, and resetting the correction amount to zero when the correction amount is smaller than the second threshold.

(5) In the display system according to (1), the correction processing device corrects the interference of the second posture variation based on magnitude of the second posture variation by calculating magnitude of the first posture variation when the second posture variation is not interfering based on an attaching angle of the detection device to the moving body and the first posture variation and the second posture variation that are detected.

By calculating the correction amount based on the magnitude of the first posture variation when the second posture variation is not interfering, the influence of the error due to the other axis interference component can be reduced. Therefore, it is possible to suppress displacement of the display position of the image.

(6) In the display system of (1), the second axes may include a plurality of axes that are different from the first axis and orthogonal to each other, and the correction processing device may set, as the second posture variation, a largest posture variation of posture variations of the moving body having each of a plurality of the axes as a rotation axis.

(7) In the display system of (1), the first axis may be a pitch axis, and the second axis may be at least one of a yaw axis and a roll axis.

By limiting the first axis, the circuit capacity can be reduced.

(8) In the display system of (1), the first axis may be a pitch axis and a roll axis, and the second axis may be a yaw axis.

(9) In the display system of (1), the first axis may be a pitch axis and a yaw axis, and the second axis may be a roll axis.

(10) The display system of (1) may further include a projection device that projects light representing an image.

(11) In the display system of (10), the moving body may be a vehicle, and the image may be a virtual image displayed in front of a windshield of a vehicle.

(12) The display device of the present disclosure includes an acquisition unit that acquires posture variation information indicating a first posture variation of a moving body having a first axis as a rotation axis and a second posture variation of the moving body having a second axis orthogonal to the first axis as a rotation axis, a display unit that displays an image at a display position based on a reference position and a correction amount, and a controller that sets the correction amount based on magnitude of the first posture variation. The controller corrects interference of the second posture variation with respect to magnitude of the first posture variation based on magnitude of the second posture variation in setting of the correction amount.

(13) A display control method of the present disclosure is performed by an arithmetic unit of a computer. The display control method includes acquiring posture variation information indicating a first posture variation of a moving body having a first axis as a rotation axis and a second posture variation of the moving body having a second axis orthogonal to the first axis as a rotation axis, displaying an image at a display position based on a reference position and a correction amount, and setting the correction amount based on magnitude of the first posture variation. Interference of the second posture variation with respect to magnitude of the first posture variation is corrected based on magnitude of the second posture variation in setting of the correction amount.

The display system, the display device, and the display control method according to all claims of the present disclosure are realized by cooperation with hardware resources, for example, a processor, a memory, and a program, and the like.

The present disclosure can be applied to a display device and a display system that display a virtual image in front of a windshield of a vehicle.

### EXPLANATIONS OF LETTERS OR NUMERALS

10 Projection device

20 Information acquisition device

21 GPS module

22 Camera

30 Display processing device

31 Communicator

32 Display controller

33 Storage

40 Posture detection device

41 Gyro sensor

50 Correction processing device

51 Communicator

52 Correction controller

521a First displacement amount calculator

521b Second displacement amount calculator

521c Third displacement amount calculator

522 Determination unit

523 Correction amount calculator

53 Storage

100 Display system

600 Display device

What is claimed is:

1. A display system comprising:
a detection device that detects a first posture variation of a moving body having a first axis as a rotation axis;
a display processing device that controls a display position of an image based on a reference position and a correction amount; and
a correction processing device that sets the correction amount based on magnitude of the first posture variation, wherein
the detection device detects a second posture variation of the moving body having a second axis orthogonal to the first axis as a rotation axis, and
the correction processing device corrects interference of the second posture variation with respect to magnitude of the first posture variation based on magnitude of the second posture variation in setting of the correction amount.

2. The display system according to claim 1, wherein
the correction processing device corrects the interference of the second posture variation based on magnitude of the second posture variation by setting an inclination amount of a posture of the moving body with respect to the second axis based on the second posture variation, and resetting the correction amount to zero when the inclination amount of the posture is larger than a first threshold.

3. The display system according to claim 1, wherein
the correction processing device corrects the interference of the second posture variation based on magnitude of the second posture variation by setting an inclination amount of a posture of the moving body with respect to the second axis based on the second posture variation, and reducing the correction amount by a predetermined amount so that the correction amount approaches zero when the inclination amount of the posture is larger than a first threshold.

4. The display system according to claim 1, wherein
the correction processing device corrects the interference of the second posture variation based on magnitude of the second posture variation by setting an inclination amount of a posture of the moving body with respect to the second axis based on the second posture variation, and, when the inclination amount of the posture is larger than a first threshold, reducing the correction amount by a predetermined amount so that the correction amount approaches zero when the correction amount is equal to or more than a second threshold and resetting the correction amount to zero when the correction amount is smaller than the second threshold.

5. The display system according to claim 1, wherein
the correction processing device corrects the interference of the second posture variation based on magnitude of the second posture variation by calculating magnitude of the first posture variation when the second posture variation is not interfering based on an attaching angle of the detection device to the moving body and the first posture variation and the second posture variation that are detected.

6. The display system according to claim 1, wherein
the second axis includes a plurality of axes that are different from the first axis and orthogonal to each other, and
the correction processing device sets, as the second posture variation, a largest posture variation of posture variations of the moving body having each of the plurality of axes as a rotation axis.

7. The display system according to claim 1, wherein
the first axis is a pitch axis, and the second axis is at least one of a yaw axis and a roll axis.

8. The display system according to claim 1, wherein
the first axis is a pitch axis and a roll axis, and the second axis is a yaw axis.

9. The display system according to claim 1, wherein
the first axis is a pitch axis and a yaw axis, and the second axis is a roll axis.

10. The display system according to claim 1, further comprising a projection device that projects light representing the image.

11. The display system according to claim 10, wherein
the moving body is a vehicle, and
the image is a virtual image displayed in front of a windshield of the vehicle.

12. A display device comprising:
an acquisition unit that acquires posture variation information indicating a first posture variation of a moving body having a first axis as a rotation axis and a second posture variation of the moving body having a second axis orthogonal to the first axis as a rotation axis;
a display unit that displays an image at a display position based on a reference position and a correction amount; and
a controller that sets the correction amount based on magnitude of the first posture variation,
wherein the controller corrects interference of the second posture variation with respect to magnitude of the first posture variation based on magnitude of the second posture variation in setting of the correction amount.

13. A display control method performed by an arithmetic unit of a computer, the display control method comprising:
acquiring posture variation information indicating a first posture variation of a moving body having a first axis as a rotation axis and a second posture variation of the moving body having a second axis orthogonal to the first axis as a rotation axis;
displaying an image at a display position based on a reference position and a correction amount; and
setting the correction amount based on magnitude of the first posture variation,
wherein interference of the second posture variation with respect to magnitude of the first posture variation is corrected based on magnitude of the second posture variation in setting of the correction amount.
